(19) United States
(12) Patent Application Publication
(10) Pub. No.: US 2026/0058758 A1
(43) Pub. Date: Feb. 26, 2026

(54) FEEDBACK IDENTIFIER REPORTING

(71) Applicant: QUALCOMM Incorporated, San Diego, CA (US)

(72) Inventors: Mostafa KHOSHNEVISAN, San Diego, CA (US); Jing SUN, San Diego, CA (US)

(21) Appl. No.: 18/811,595

(22) Filed: Aug. 21, 2024

(51) Int. Cl. H04L 1/1812; H04L 5/00; H04W 72/231; H04W 76/20

(52) U.S. Cl. CPC H04L 1/1812; H04L 5/0053; H04W 72/231; H04W 76/20

(57) ABSTRACT

Various aspects of the present disclosure generally relate to wireless communication. In some aspects, a user equipment (UE) may receive a downlink communication associated with a hybrid automatic repeat request (HARQ) process identifier. The UE may initiate a timer associated with the HARQ process identifier in accordance with the downlink communication or in accordance with a feedback communication associated with the downlink communication. The UE may transmit an indication of an event associated with the HARQ process identifier in association with an expiration of the timer. Numerous other aspects are described.

### FIELD OF THE DISCLOSURE

Aspects of the present disclosure generally relate to wireless communication and specifically relate to techniques, apparatuses, and methods for feedback identifier reporting.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IOT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, an apparatus for wireless communication at a user equipment (UE) includes one or more memories; and one or more processors, coupled to the one or more memories, configured to cause the UE to: receive a downlink communication associated with a hybrid automatic repeat request (HARQ) process identifier; initiate a timer associated with the HARQ process identifier in accordance with the downlink communication or in accordance with a feedback communication associated with the downlink communication; and transmit an indication of an event associated with the HARQ process identifier in association with an expiration of the timer.

In some aspects, an apparatus for wireless communication at a network node includes one or more memories; and one or more processors, coupled to the one or more memories, configured to cause the network node to: transmit a downlink communication associated with a HARQ process identifier; and receive an indication of an event associated with the HARQ process identifier in association with an expiration of a timer associated with the downlink communication or associated with a feedback communication associated with the downlink communication.

In some aspects, a method of wireless communication performed by a UE includes receiving a downlink communication associated with a HARQ process identifier; initiating a timer associated with the HARQ process identifier in accordance with the downlink communication or in accordance with a feedback communication associated with the downlink communication; and transmitting an indication of an event associated with the HARQ process identifier in association with an expiration of the timer.

In some aspects, a method of wireless communication performed by a network node includes transmitting a downlink communication associated with a HARQ process identifier; and receiving an indication of an event associated with the HARQ process identifier in association with an expiration of a timer associated with the downlink communication or associated with a feedback communication associated with the downlink communication.

In some aspects, a non-transitory computer-readable medium storing a set of instructions for wireless communication includes one or more instructions that, when executed by one or more processors of a UE, cause the UE to: receive a downlink communication associated with a HARQ process identifier; initiate a timer associated with the HARQ process identifier in accordance with the downlink communication or in accordance with a feedback communication associated with the downlink communication; and transmit an indication of an event associated with the HARQ process identifier in association with an expiration of the timer.

In some aspects, a non-transitory computer-readable medium storing a set of instructions for wireless communication includes one or more instructions that, when executed by one or more processors of a network node, cause the network node to: transmit a downlink communication associated with a HARQ process identifier; and receive an indication of an event associated with the HARQ process identifier in association with an expiration of a timer associated with the downlink communication or associated with a feedback communication associated with the downlink communication.

In some aspects, an apparatus for wireless communication includes means for receiving a downlink communication associated with a HARQ process identifier; means for initiating a timer associated with the HARQ process identifier in accordance with the downlink communication or in accordance with a feedback communication associated with the downlink communication; and means for transmitting an indication of an event associated with the HARQ process identifier in association with an expiration of the timer.

In some aspects, an apparatus for wireless communication includes means for transmitting a downlink communication associated with a HARQ process identifier; and means for receiving an indication of an event associated with the HARQ process identifier in association with an expiration of a timer associated with the downlink communication or associated with a feedback communication associated with the downlink communication.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with identifying unsuccessful terminations of hybrid automatic repeat request (HARQ) processes, in accordance with the present disclosure.

FIG. 5 is a diagram illustrating an example associated with unsuccessful terminations of HARQ processes, in accordance with the present disclosure.

FIG. 6 is a diagram illustrating an example of signaling exchanged between a transmitting and receiving device, in accordance with the present disclosure.

FIG. 7 is a diagram of an example associated with feedback identifier reporting, in accordance with the present disclosure.

FIG. 8 is a diagram illustrating an example of signaling exchanged between a transmitting and receiving device, in accordance with the present disclosure.

FIG. 9 is a diagram illustrating an example of signaling exchanged between a transmitting and receiving device, in accordance with the present disclosure.

FIG. 10 is a diagram illustrating an example of signaling exchanged between a transmitting and receiving device, in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, devices (for example, a user equipment (UE), a network node) may perform a hybrid automatic repeat request (HARQ) process to improve a reliability of communications exchanged between the devices. For example, a transmitting device may send a transport block (for example, data) to a receiving device, and the receiving device may attempt to decode the data. In cases where the receiving device successfully decodes the data, the receiving device may transmit a HARQ acknowledgement (ACK) message to the transmitting device. Additionally, in cases where the receiving device fails to successfully decode the data, the receiving device may transmit a HARQ negative ACK (NACK) message to the transmitting device. In response to receiving a HARQ NACK message from the receiving device, the transmitting device may perform a retransmission associated with the transport block. For example, the transmitting device may retransmit a portion of the transport block (for example, corresponding to the portion of the transport block that the receiving device was unable to successfully decode). Additionally, or alternatively, the transmitting device may retransmit the transport block using a same or different redundancy version (for example, using the same or different set of coded bits associated with the transport block), which may allow for the receiving device to perform soft combining or incremental redundancy combining. Upon receiving the retransmission from the transmitting device, the receiving device may attempt to decode the transport block using a combination of the data received in the initial transmission of the transport block and the data received in the retransmission.

In some cases, the transmitting device may continue to send retransmissions associated with the transport block until the transmitting device receives a HARQ ACK message from the receiving device (for example, indicating that the receiving device successfully decoded the transport block). In response to receiving the HARQ ACK message from the receiving device, the transmitting device may terminate the HARQ process. To terminate the HARQ process, the transmitting device may discard data associated with the transport block (for example, from a buffer that is maintained prior to the termination of the HARQ process). In some other cases, the transmitting device may terminate the HARQ process without receiving a HARQ ACK message from the receiving device. For example, the transmitting device may terminate the HARQ process after a quantity of retransmissions performed by the transmitting device satisfies (for example, is equal to or greater than) a quantity threshold associated with a quantity of retransmissions.

In a first example, the receiving device may receive first control information (e.g., downlink control information (DCI)) that schedules the transmission of a first transport block, and may indicate that the transport block is associated with a first HARQ identifier and an new data indicator (NDI) (e.g., indicating whether the transport block is an initial transmission or a retransmission) having a first value. The receiver may successfully receive and/or decode the first transport block. Therefore, the receiver may transmit a feedback communication for the first transport block that includes a HARQ ACK indication (e.g., indicating the successful decoding of the first transport block). Later, the receiver may receive second control information to schedule the transmission of a second (e.g., different) transport block, and may indicate that the second transport block is associated with the same HARQ identifier as the first transport block and a different NDI value (e.g., the NDI indicated by the second control information may have a different value than the NDI indicated by the first control information). However, the NDI value of the second control information may be incremented from the NDI value of the first control information by more than a single step value (e.g., in scenarios where the quantity of bits for (e.g., allocated to, dedicated to, reserved for, included in) an NDI field of the DCI is equal to two or more bits). Therefore, the reception of the second control information may be indicative of an unsuccessful termination of the HARQ process for an intervening transport block.

In a second example, the receiver may receive first control information that schedules the transmission of a first transport block, and may indicate that the first transport block is associated with a first HARQ identifier and a first NDI value. The receiver may successfully receive and/or decode the first transport block. Therefore, the receiver may transmit a feedback communication that includes a HARQ ACK indication (e.g., indicating the successful decoding of the first transport block). Later, the receiver may receive second control information to schedule the transmission of a second (e.g., different) transport block, and may indicate that the second transport block is associated with the same HARQ identifier as the transport block and the same NDI value. Because the receiver transmitted the HARQ ACK indication for the first transport block, the receiver may expect that a next control information for the first HARQ identifier will have a different NDI value. For example, the receiver may fail to detect or receive one or more control information message (e.g., that include the expected NDI value) scheduling another transport block prior to receiving the second control information. Therefore, the receiver may identify that the reception of the second control information is indicative of an unsuccessful termination of the HARQ process for the intervening transport block.

As described above, the reception of a subsequent DCI may indicate to the receiver that there has been an unsuccessful termination of a HARQ process. However, in some cases, there may be a significant delay between DCI receptions for a given HARQ process (e.g., a given HARQ identifier may not be used again by the transmitter or there may be a large time gap between uses of the given HARQ identifier) and/or the receiver may fail to receive or decode the subsequent DCI. This increases automatic repeat request (ARQ) latency because of the increased delay associated with reporting the unsuccessful termination of the HARQ process.

Various aspects relate generally to a UE using a timer to reduce the ARQ latency associated with reporting the unsuccessful termination of a HARQ process. Some aspects more specifically relate to the UE reporting potentially unsuccessful HARQ terminations due to the UE being unaware of whether a network node attempted to schedule an intervening transport block without waiting for subsequent control information. In some aspects, the UE may receive a downlink communication associated with a HARQ process identifier, and may initiate a timer associated with the HARQ process identifier. In some aspects, when the timer expires, the UE may transmit an indication of an event (e.g., indicative of a potentially unsuccessful HARQ termination) associated with the HARQ process identifier.

For example, the UE may detect and report instances where a transport block associated with a HARQ process identifier is successfully decoded and the UE receives another transport block associated with the same HARQ process identifier. Additionally, the UE may detect and report instances where a transport block associated with a HARQ identifier is associated with an NDI value that is different from an expected value (for example, which may correspond to instances where the UE previously failed to receive or decode control information scheduling another transport block associated with the same HARQ identifier and the other transport block). In both instances, the UE detecting and reporting the unsuccessful termination of the HARQ process based on the HARQ identifiers associated with the transport blocks, the UE successfully decoding the transport block, and/or a value of the NDI may enable the UE to detect and report errors prior to receiving additional control information. Thus, the network node may initiate an ARQ process (for example, in response to receiving the report from the UE that indicates the unsuccessful termination of the HARQ process) prior to the expiration of the timer.

Particular aspects of the subject matter described in this disclosure can be implemented to realize one or more of the following potential advantages. In some examples, the described techniques can be used to decrease a latency and signaling overhead associated with communications between devices. For example, the UE detecting and reporting potentially unsuccessful HARQ terminations may decrease the latency associated with initiating retransmissions without increasing signaling overhead. Additionally, the described techniques can be used to decrease complexity (e.g., the difficultness and/or the amount of resources use to implement, manage, and/or optimize various aspects of a wireless communications system) at the UE by decreasing buffering at the UE (or at another receiving device). For example, if a latency associated with receiving missing packets is reduced by decreasing a delay associated with initiating ARQ processes, the UE can decrease a usage of a data storage buffer. Further, the described techniques may be used to decrease complexity at the network node by decreasing buffering at the network (or, for example, at another transmitting device). For example, by identifying packets for ARQ retransmission associated with the UE reporting potentially unsuccessful HARQ terminations, the transmitting device may remove received packets from a buffer of the receiving device sooner than if the network node were to wait to receive feedback for a subsequent DCI.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IOT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) user equipment (UE) functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

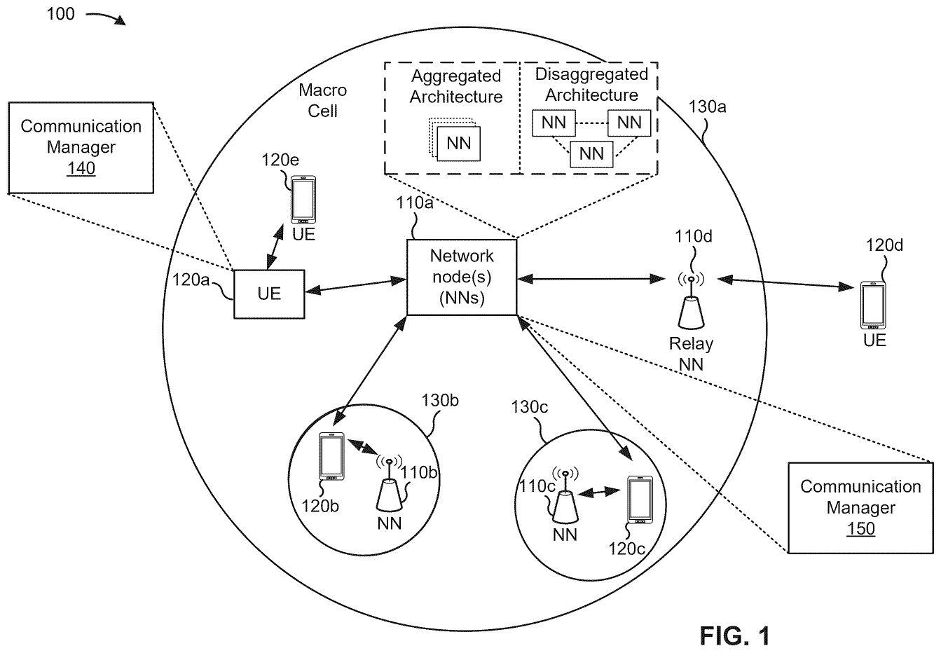

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally, or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally, or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally, or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced MTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IOT (narrowband IoT) devices. An IoT UE or NB-IOT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, cMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IOT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an uplink (UL) communication to a network node 110, which then transmits the data to the UE 120e in a downlink (DL) communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a downlink communication associated with a HARQ process identifier; initiate a timer associated with the HARQ process identifier in accordance with the downlink communication or in accordance with a feedback communication associated with the downlink communication; and transmit an indication of an event associated with the HARQ process identifier in association with an expiration of the timer. Additionally, or alternatively, the communication manager 140 may perform one or more other operations described herein.

In some aspects, the network node 110 may include a communication manager 150. As described in more detail elsewhere herein, the communication manager 150 may transmit a downlink communication associated with a HARQ process identifier; and receive an indication of an event associated with the HARQ process identifier in association with an expiration of a timer associated with the downlink communication or associated with a feedback communication associated with the downlink communication. Additionally, or alternatively, the communication manager 150 may perform one or more other operations described herein.

As indicated above, FIG. 1 is provided as an example. Other examples may differ from what is described with regard to FIG. 1.

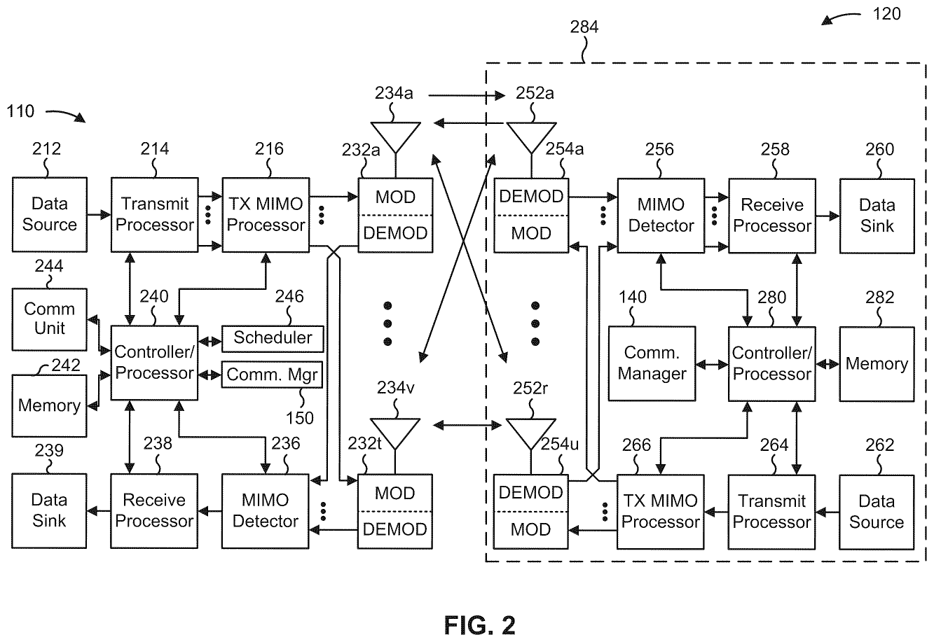

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

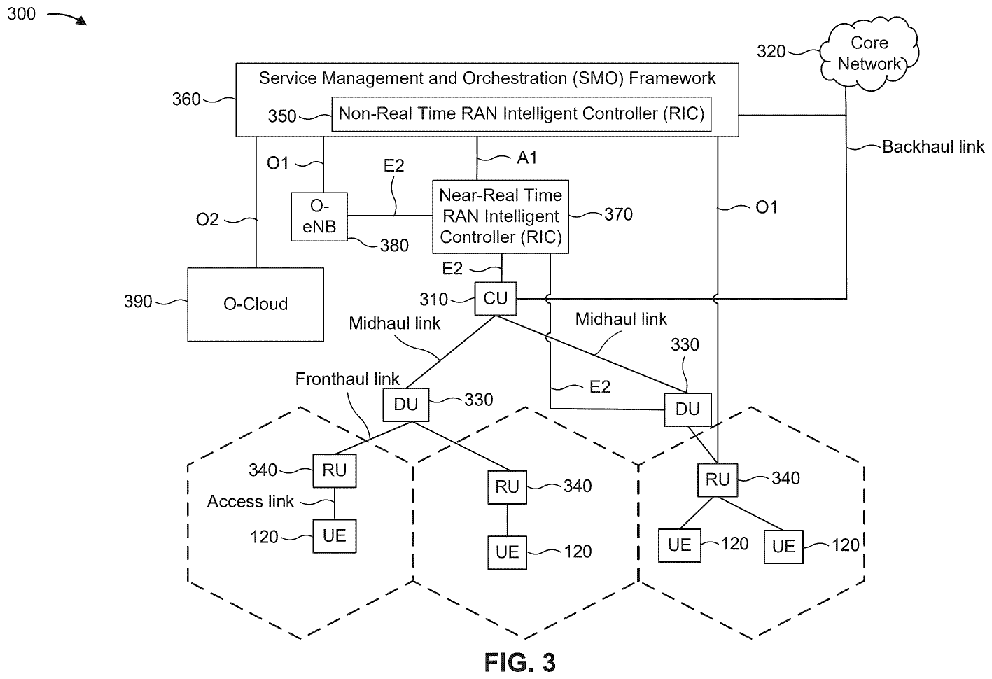

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

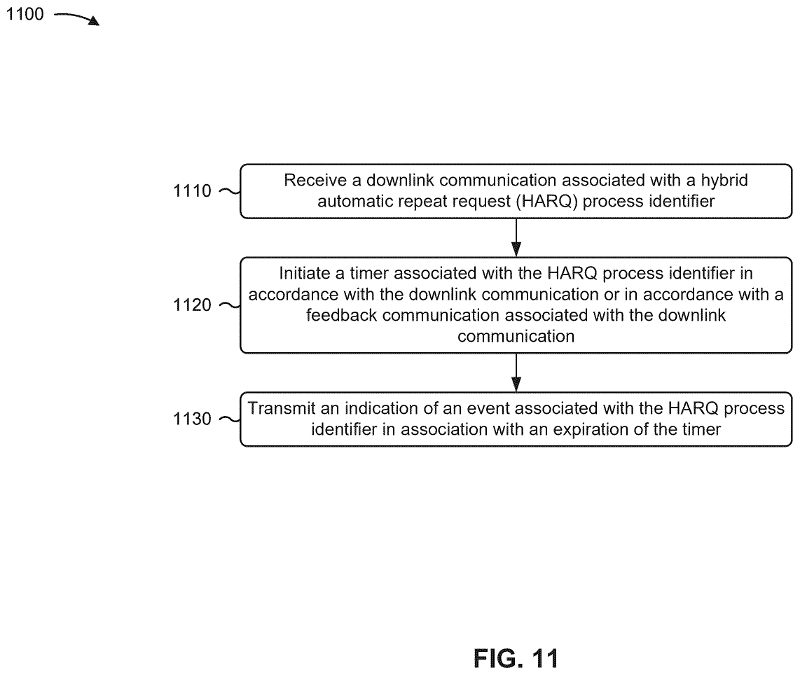

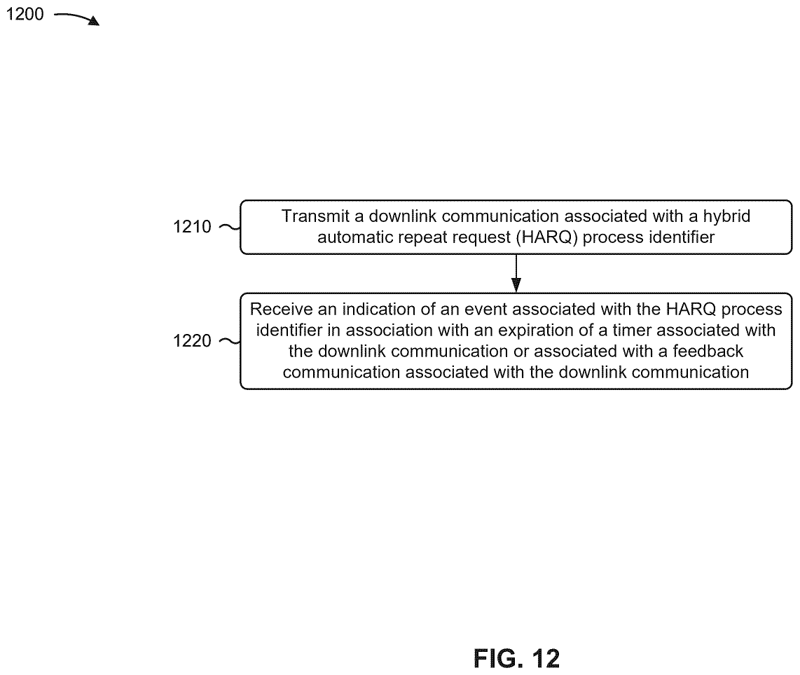

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with feedback identifier reporting, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1100 of FIG. 11, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, the UE 120 includes means for receiving a downlink communication associated with a HARQ process identifier; means for initiating a timer associated with the HARQ process identifier in accordance with the downlink communication or in accordance with a feedback communication associated with the downlink communication; and/or means for transmitting an indication of an event associated with the HARQ process identifier in association with an expiration of the timer. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a downlink communication associated with a HARQ process identifier; and/or means for receiving an indication of an event associated with the HARQ process identifier in association with an expiration of a timer associated with the downlink communication or associated with a feedback communication associated with the downlink communication. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

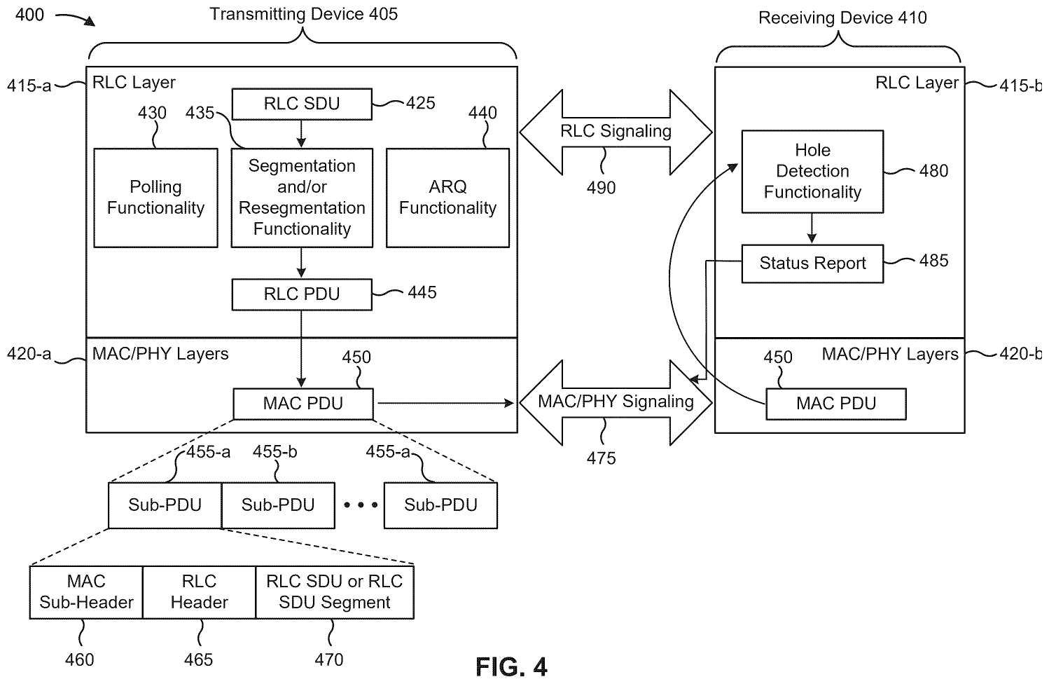

FIG. 4 is a diagram illustrating an example 400 associated with identifying unsuccessful terminations of HARQ processes, in accordance with the present disclosure. As shown in FIG. 4, a transmitting device 405 and a receiving device 410 may communicate with one another. For example, the transmitting device 405 may transmit, to the receiving device 410, the MAC packet data unit (PDU) 450.

In some cases, the transmitting device 405 may correspond to a network node 110, the receiving device 410 may correspond to a UE 120, and the transmitting device 405 may transmit communications to the receiving device 410 via a downlink. In some other cases, the transmitting device 405 may correspond to a UE 120, the receiving device 410 may correspond to a network node 110, and the transmitting device 405 may transmit communications to the receiving device 410 via an uplink.

Both the transmitting device 405 and the receiving device 410 may include an RLC layer 415 and MAC/PHY layers 420 (for example, including a MAC layer, a PHY layer, or both a MAC layer and a PHY layer). Although not illustrated, the transmitting device 405 and the receiving device 410 may also include additional layers, such as PDCP layers, RRC layers, and/or SDAP layers. In the example 400, the RLC layer 415-a of the transmitting device 405 and the RLC layer 415-b of the receiving device 410 may exchange RLC signaling 490. Additionally, the MAC/PHY layers 420-a of the transmitting device 405 and the MAC/PHY layers 420-b of the receiving device 410 may exchange MAC/PHY signaling 475.

In the example 400, the RLC layer 415-a of the transmitting device 405 may receive the RLC service data unit (SDU) 425 from a PDCP layer of the transmitting device 405. The RLC layers 415 (for example, RLC layer 415-a and RLC layer 415-b) may have multiple different modes. In particular, the transmitting device 405 and the receiving device 410 may operate the RLC layers 415 in accordance with a transparent mode, an unacknowledged mode, or an acknowledged mode. In an example where the RLC layer 415-a is operating in accordance with the transparent mode, the receiving device 410 may pass the RLC SDU 425 through the RLC layer 415-a (for example, from the PDCP layer to the MAC layer of the transmitting device 405) as an RLC PDU 445 without additional processing by the RLC layer 415-a. In another example where the RLC layer 415-a is operating in accordance with the unacknowledged mode, the transmitting device 405 may perform segmentation functionality (for example, of the segmentation and/or resegmentation functionality 435 illustrated in example 400), but may not perform the ARQ functionality 440. In another example where the RLC layer 415-a is operating in accordance with the acknowledged mode, the transmitting device 405 may perform the segmentation and/or resegmentation functionality 435 and the ARQ functionality 440.

When operating the RLC layer 415-a in accordance with the acknowledgement mode, the transmitting device 405 may perform the segmentation and/or resegmentation functionality 435 to fit the RLC SDU 425 into available resources (for example, for transmission). For example, the transmitting device 405 may segment the RLC SDU 425 to generate multiple RLC SDU segments. The transmitting device 405 may perform re-segmentation functionalities (for example, of the segmentation and/or resegmentation functionality 435) to support the ARQ functionality 440, where an available payload size may change.

The RLC layer 415-a of the transmitting device 405 may generate the RLC PDU 445, which may include the RLC SDU 425. In some cases, the RLC PDU 445 may include one or multiple RLC SDUs 425 or one or multiple RLC SDU segments (for example, generated by the segmentation functionality of the segmentation and/or resegmentation functionality 435) associated with the RLC SDU 425. Each RLC SDU segment in the RLC PDU 445 may include a header that includes a sequence number associated with the RLC SDU segment. Then, the RLC layer 415-a may provide the RLC PDU 445 to the MAC/PHY layers 420-a of the transmitting device, and the MAC/PHY layers 420-a may receive the MAC PDU 450.

The MAC PDU 450 may correspond to a transport block (for example, transmitted from the transmitting device 405 to the receiving device via the MAC/PHY signaling 475). The MAC PDU 450 may include one or multiple sub-PDUs 455 (for example, MAC SDUs). Each sub-PDU 455 may include a MAC sub-header 460, an RLC header 465, and an RLC SDU or RLC SDU segment 470. In some examples, the RLC PDU 445 may correspond to the RLC header 465 and the RLC SDU or RLC SDU segment 470 in each sub-PDU 455. The RLC header 465 may include information related to the RLC SDU or RLC SDU segment 470. For example, the RLC header 465 may include a sequence number associated with the RLC SDU or RLC SDU segment 470, segmentation information associated with an RLC SDU segment of the RLC SDU or RLC SDU segments 470, and/or a segment offset associated with an RLC SDU segment of the RLC SDU or RLC SDU segments 470.

The MAC/PHY layers 420-a of the transmitting device 405 may transmit, via the MAC/PHY signaling 475, the MAC PDU 450 to the receiving device 410. The MAC/PHY layers 420-b of the receiving device 410 may provide the MAC PDU 450 to the RLC layer 415-b of the receiving device 410. The receiving device 410 may perform a HARQ process associated with the MAC PDU 450. For example, in cases where the receiving device 410 successfully decodes the MAC PDU 450, the receiving device 410 may transmit a HARQ ACK message to the transmitting device 405 via the MAC/PHY signaling 475. Alternatively, in cases where the receiving device 410 fails to successful decode the MAC PDU 450, the receiving device 410 may transmit a HARQ NACK message to the transmitting device 405 via the MAC/PHY signaling 475. In response to receiving a HARQ NACK message from the receiving device 410, the transmitting device 405 may perform a retransmission associated with the MAC PDU 450. For example, the transmitting device 405 may retransmit a portion of the MAC PDU 450 (for example, that is selected based on the portion of the MAC PDU 450 that the receiving device 410 was unable to successfully decode). Upon receiving the retransmission from the transmitting device 405, the receiving device 410 may attempt to decode the MAC PDU 450 using a combination of the data received in the initial transmission of the transport block and the data received in the retransmission.

In some cases, the transmitting device 405 may continue to transmit retransmissions associated with the MAC PDU 450 until the transmitting device 405 receives a HARQ ACK message from the receiving device 410 (for example, indicating that the receiving device successfully decodes the MAC PDU 450). In response to receiving the HARQ ACK message from the receiving device 410, the transmitting device 405 may terminate the HARQ process. In some other cases, the transmitting device 405 may terminate the HARQ process without receiving a HARQ ACK message from the receiving device 410. For example, the transmitting device 405 may terminate the HARQ process after a quantity of retransmissions performed by the transmitting device 405 satisfies (for example, is equal to or greater than) a quantity threshold associated with a quantity of retransmissions.

In cases where the RLC layer 415-b of the receiving device is operating in accordance with the acknowledgement mode, the receiving device 410 may additionally perform an ARQ process. For example, the RLC layer 415-b of the receiving device 410 may support the ARQ functionality 440. Here, the RLC layer 415-b of the receiving device 410 may have a hole detection functionality 480, which may enable the receiving device 410 to detect holes (for example, to detect one or more RLC SDU segments 470 in a MAC PDU 450 that the receiving device 410 has failed to decode). In some cases, the receiving device 410 may detect holes based on a sequence number associated with the RLC SDU or RLC SDU segments 470 (for example, included in the RLC header 465), segmentation information associated with the RLC SDU or RLC SDU segments 470 (for example, included in the RLC header 465, included in the MAC sub-header 460), and/or a segment offset associated with the RLC SDU or RLC SDU segments 470 (for example, included in the RLC header 465, included in the MAC sub-header 460). In some instances, the receiving device 410 may detect the holes with or without assistance from a lower layer (for example, MAC/PHY layers 420-b of the receiving device 410).

The receiving device 410 may detect holes associated with a transmission of the MAC PDU 450 based on a timer (for example, a t-Reassembly timer). For example, the receiving device 410 may identify one or more missing RLC SDUs or RLC SDU segments 470 based on the sequence numbers associated with RLC SDUs or RLC SDU segments 470 that have been successfully received and decoded. The receiving device 410 may initiate the timer in response to identifying that one or more RLC SDUs or RLC SDU segments 470 are missing. If, prior to an expiration of the timer, the receiving device 410 does successfully receive and decode the one or more missing RLC SDUs or RLC SDU segments 470 (for example, as part of a HARQ process associated with the MAC PDU 450), then the receiving device 410 may reset the timer. Additionally, if the receiving device 410 does not successfully receive and decode the one or more missing RLC SDUs or RLC SDU segments 470 prior to the expiration of the timer, then the receiving device 410 may generate and transmit the status report 485 to the transmitting device 405.

In one example, the receiving device may detect holes as part of the RLC process in instances of a HARQ NACK to HARQ ACK error. In this example, the receiving device 410 may transmit a HARQ NACK to the transmitting device 405, and the transmitting device 405 may interpret the HARQ NACK as a HARQ ACK. As a result, the transmitting device 405 may terminate the HARQ process (for example, may stop HARQ transmissions and/or retransmissions for the MAC PDU 450).

In the example 400, the receiving device 410 may detect NACK to ACK errors prior to an expiration of the timer associated with the hole detection functionality 480 (for example, prior to the expiration of the t-Reassembly timer). In particular, the receiving device 410 may detect the NACK to ACK errors based on detecting an unsuccessful termination of a HARQ process (for example, due to a NACK to ACK error) associated with the MAC PDU 450. Then, the receiving device 410 may report the unsuccessful termination of the HARQ process associated with the MAC PDU 450 to the transmitting device 405. For example, the receiving device 410 may detect and report instances where a MAC PDU 450 associated with a HARQ process identifier is not decoded and the receiving device 410 receives another MAC PDU 450 associated with the same HARQ process identifier. Additionally, the receiving device 410 may detect and report instances where a MAC PDU 450 associated with a HARQ identifier is associated with an NDI value that is different from an expected value (for example, which may correspond to instances where the receiving device 410 previously failed to receive or decode control information scheduling another MAC PDU 450 associated with the same HARQ identifier and the other MAC PDU 450).

The status report 485 may be associated with a timer (for example, a t-StatusProhibit timer). Here, the receiving device 410 may refrain from transmitting the status report 485 until the timer expires. In some cases, the receiving device 410 waiting until the timer expires to transmit the status report 485 may decrease a periodicity associated with the receiving device 410 sending status reports 485. That is, after the receiving device 410 sends a status report 485, the receiving device 410 may reset and start (for example, initiate) the timer and may be unable to send another status report 485 until an expiration of the timer. The status report 485 may include RLC ACK and/or RLC NACK for certain sequence numbers (for example, associated with the MAC PDU 450).

The receiving device 410 may transmit a status report 485 in response to a polling request from the transmitting device 405. For example, the transmitting device 405 may include the polling functionality 430 at the RLC layer 415-a. In this example, the transmitting device may transmit, to the receiving device 410 (for example, via the RLC signaling 490, via the MAC/PHY signaling 475) a polling request triggering the receiving device 410 to transmit the status report 485 to the transmitting device 405. The transmitting device 405 may transmit the polling request based on a quantity of MAC PDUs 450 transmitted to the receiving device 410. For example, the transmitting device 405 may transmit the polling request after transmitting a certain quantity of MAC PDUs 450 (for example, as indicated by a variable such as a pollPDU variable). In another case, the transmitting device 405 may transmit the polling request based on a quantity of bytes transmitted (for example, via one or more MAC PDUs 450) to the receiving device 410. For example, the transmitting device 405 may transmit the polling request after transmitting a certain quantity of bytes (for example, as indicated by a variable such as a pollByte variable).

The receiving device 410 may transmit the status report 485 via the MAC/PHY signaling 475 or, in some other cases, via the RLC signaling 490. In response to receiving the status report 485, the transmitting device 405 may perform an ARQ process (for example, using the ARQ functionality 440 of the RLC layer 415-a). For example, the transmitting device 405 may retransmit any of the RLC SDU or RLC SDU segments 470 that correspond to a sequence number indicated as not successfully received and decoded in the status report 485. In some cases, the transmitting device 405 may continue transmitting retransmissions of any RLC SDUs or RLC SDU segments 470 until the receiving device 410 indicates that the RLC SDUs or RLC SDU segments 470 have been successfully received and decoded (for example, via an RLC ACK for the sequence numbers associated with the RLC SDUs or RLC SDU segments 470). Additionally, or alternatively, the transmitting device 405 may refrain from transmitting a retransmission of an RLC SDU or RLC SDU segment 470 in instances where a quantity of retransmissions associated with that RLC SDU or RLC SDU segment 470 is greater than a threshold (for example, a maxRetxThreshold).

As indicated above, FIG. 4 is provided as an example. Other examples may differ from what is described with regard to FIG. 4.

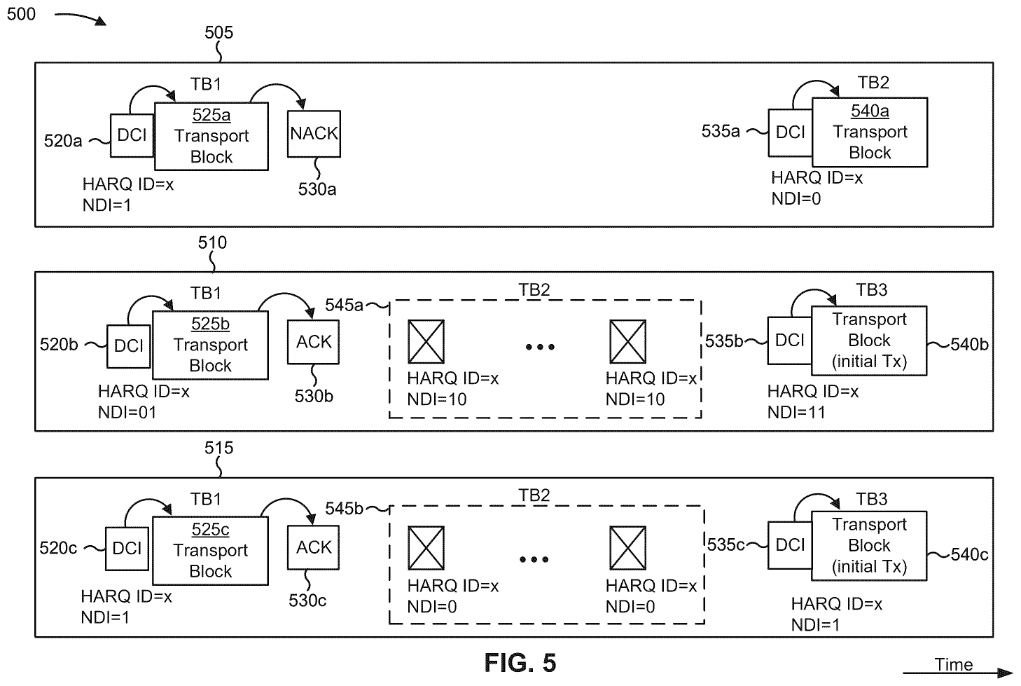

FIG. 5 is a diagram illustrating an example 500 associated with unsuccessful terminations of HARQ processes, in accordance with the present disclosure. The example 500 depicts a first event 505 indicative of an unsuccessful terminations of a HARQ process, a second event 510 indicative of an unsuccessful terminations of a HARQ process, and a third event 515 indicative of an unsuccessful terminations of a HARQ process. The example 500 depicts one or more signals received (or failed to be received, as indicated by the signals being depicted within a box having dashed lines) by a UE 120.

For example, for the first event 505, the UE 120 may receive DCI 520a that schedules the transmission of a first transport block 525a (shown as TB1 in FIG. 5), and may indicate that the transport block 525a is associated with a HARQ identifier x and an NDI having a value of “1.” The UE 120 may not successfully receive and decode the transport block 525a, and may transmit a feedback communication 530a that includes a HARQ NACK indication (e.g., indicating that the transport block 525a was not successfully received or decoded by the UE 120). Later, the UE 120 may receive DCI 535a to schedule the transmission of a second (e.g., different) transport block 540a (shown as TB2 in FIG. 5), and may indicate that the transport block 540a is associated with the same HARQ identifier as the transport block 525a (e.g., HARQ identifier x) and a different NDI value of “0” (e.g., the NDI indicated by the DCI 535a may have a different value than the NDI indicated by the DCI 520a to indicate that a new transport block is being communicated for the HARQ identifier x). The reception of the DCI 535a (scheduling a new transport block for the HARQ identifier x) may be indicative to the UE 120 of an unsuccessful termination of the HARQ process for the first transport block 525a (e.g., and the HARQ identifier x) because the UE 120 may expect to receive a retransmission of the first transport block 525a after transmitting the feedback communication 530a that includes the HARQ NACK indication.

As another example, for the second event 510, the UE 120 may receive DCI 520b that schedules the transmission of a first transport block 525b (shown as TB 1 in FIG. 5), and may indicate that the transport block 525b is associated with a HARQ identifier x and an NDI having a value of “01.” The UE 120 may successfully receive and/or decode the transport block 525b. Therefore, the UE 120 may transmit a feedback communication 530b that includes a HARQ ACK indication (e.g., indicating the successful decoding of the transport block 525b). Later, the UE 120 may receive DCI 535b to schedule the transmission of a second (e.g., different) transport block 540a (shown as TB3 in FIG. 5), and may indicate that the transport block 540b is associated with the same HARQ identifier as the transport block 525b (e.g., HARQ identifier x) and a different NDI value of “11” (e.g., the NDI indicated by the DCI 535b may have a different value than the NDI indicated by the DCI 520b). However, as shown in FIG. 5, the NDI value of the DCI 535b may be incremented from the NDI value of the DCI 520b by more than a single step value. For example, the UE 120 may expect that a next DCI for the HARQ identifier x will have a value of “10” after the UE 120 transmits the HARQ ACK indication. For example, as shown by reference number 545a, the UE 120 may fail to detect or receive one or more DCI communications (e.g., that include the expected NDI value of “10”) scheduling another transport block (shown as TB2 in FIG. 5) prior to receiving the DCI 535b. Therefore, the reception of the DCI 535b may be indicative of an unsuccessful termination of the HARQ process for the TB2.

As another example, for the third event 515, the UE 120 may receive DCI 520c that schedules the transmission of a first transport block 525c (shown as TB1 in FIG. 5), and may indicate that the transport block 525c is associated with a HARQ identifier x and an NDI having a value of “1.” The UE 120 may successfully receive and/or decode the transport block 525c. Therefore, the UE 120 may transmit a feedback communication 530c that includes a HARQ ACK indication (e.g., indicating the successful decoding of the transport block 525c). Later, the UE 120 may receive DCI 535c to schedule the transmission of a second (e.g., different) transport block 540c (shown as TB3 in FIG. 5), and may indicate that the transport block 540c is associated with the same HARQ identifier as the transport block 525c (e.g., HARQ identifier x) and the same NDI value of “1” (e.g., the NDI indicated by the DCI 535c may have the same value than the NDI indicated by the DCI 520c). Because the UE 120 transmitted the HARQ ACK indication for the transport block 525c, the UE 120 may expect that a next DCI for the HARQ identifier x will have a different NDI value. For example, as shown by reference number 545b, the UE 120 may fail to detect or receive one or more DCI communications (e.g., that include the expected NDI value of “0”) scheduling another transport block (shown as TB2 in FIG. 5) prior to receiving the DCI 535b. Therefore, the reception of the DCI 535c may be indicative of an unsuccessful termination of the HARQ process for the TB2.

As described above, the reception of a subsequent DCI (e.g., the DCI 535a, the DCI 535b, or DCI 535c) may indicate to the UE 120 that there has been an unsuccessful termination of a HARQ process. However, in some cases, there may be a significant delay between DCI receptions for a given HARQ process (e.g., a given HARQ identifier may not be used again by the network node 110 or there may be a large time gap between uses of the given HARQ identifier) and/or the UE 120 may fail to receive or decode the subsequent DCI. This increases ARQ latency because of the increased delay associated with reporting the unsuccessful termination of the HARQ process. Therefore, in cases where the UE 120 expects a subsequent DCI (e.g., when the UE 120 transmits a HARQ NACK indication, such as in the first event 505), the UE 120 may use a timer to reduce the ARQ latency associated with reporting the unsuccessful termination of a HARQ process.

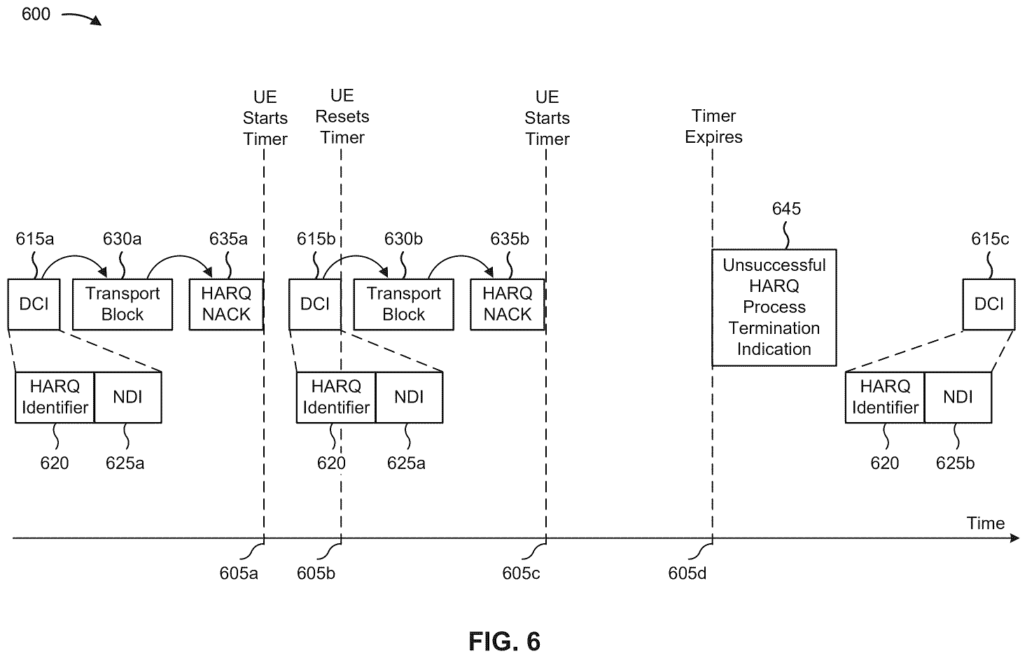

For example, the UE 120 may start the timer in response to transmitting a HARQ NACK indication for a given transport block (e.g., the transport block 525a). If the timer expires prior to the UE 120 detecting a retransmission associated with the given transport block (e.g., the transport block 525a) or prior to the UE 120 detecting DCI scheduling a new transport block associated with the same HARQ identifier (such as the DCI 535a), then the UE 120 may identify an unsuccessful termination of the HARQ process associated with the given transport block, as described in further detail with regard to FIG. 6. However, in other cases (such when the UE 120 transmits a HARQ ACK indication for a given transport block associated with a HARQ process as depicted in the second event 510 and the third event 515), the UE 120 may be unaware of whether a subsequent DCI is expected. Therefore, the UE 120 may still experience the increased ARQ latency for reporting unsuccessful termination of the HARQ processes in cases where the UE 120 transmits a HARQ ACK indication for a given transport block.

As indicated above, FIG. 5 is provided as an example. Other examples may differ from what is described with regard to FIG. 5.

FIG. 6 is a diagram illustrating an example 600 of signaling exchanged between a transmitting and receiving device (for example, between a network node 110 and a UE 120), in accordance with the present disclosure.

FIG. 6 illustrates an example where the network node 110 configures a timer associated with the UE 120 identifying unsuccessful terminations of HARQ processes, for example, as related to event 505 of FIG. 5. In particular, the network node 110 may indicate for the UE 120 to identify an unsuccessful HARQ process termination in response to an expiration of a timer. In particular, the UE 120 may start the timer in response to transmitting a HARQ NACK 635 for a transport block 630. If the timer expires prior to the UE 120 detecting a retransmission associated with the transport block 630 or prior to the UE 120 detecting a DCI 615 scheduling a new transport block associated with the same HARQ identifier 620 (such as a DCI 615 indicating the same HARQ identifier 620 but a different NDI 625), the UE 120 may identify an unsuccessful termination of the HARQ process associated with the transport block 630.

The network node 110 may transmit signaling to the UE 120 configuring a value for the timer. For example, the network node 110 may transmit (for example, via RRC signaling) signaling indicating the value for the timer.

In the example 600, the DCI 615a may schedule an initial transmission of the transport block 630a, and may indicate that the transport block 630a is associated with the HARQ identifier 620 and an NDI 625a. However, the UE 120 may be unable to successfully decode the initial transmission of the transport block 630a, and at time 605a may transmit a HARQ NACK 635a to the network node 110 and start (for example, initiate) the timer. At time 605b, the network node 110 may schedule a retransmission of the transport block 630b (for example, via the DCI 615b which indicates the same HARQ identifier 620 and NDI 625a as the initial transmission of the transport block 630a). Additionally, if the UE 120 receives a DCI 615b that indicates a same HARQ identifier 620 (for example, with the same or different NDI 625), the UE 120 may stop and reset the timer. Therefore, at time 605b, the UE 120 may stop and reset the timer based on the DCI 615b indicating the same HARQ identifier 620 as the DCI 615a. In the example 600, the UE 120 receives the DCI 615b scheduling the retransmission of the transport block 630b prior to the expiration of the timer. Accordingly, the UE 120 does not detect an unsuccessful termination of the HARQ process associated with the transport block 630 between times 605a and 605b.

In the example 600, the UE 120 is unable to successfully decode the transport block 630 using a combination of the initial transmission of the transport block 630a and the retransmission of the transport block 630b. Accordingly, at time 605c the UE 120 transmits another HARQ NACK 635b associated with the transport block 630 and starts (for example, initiates) the timer.

At time 605d, the timer may expire. In response to the timer expiring prior to the UE 120 detecting any downlink control information 615 scheduling another retransmission associated with the transport block 630, the UE 120 may identify an unsuccessful HARQ process termination associated with the transport block 630 and the HARQ identifier 620. Accordingly, the UE 120 may transmit the unsuccessful HARQ process termination indication 645 to the network node 110.

In some cases, the network node 110 configuring the UE 120 to identify unsuccessful HARQ process terminations in response to an expiration of a timer may decrease a latency associated with the UE 120 detecting and reporting unsuccessful HARQ process terminations. For example, the network node 110 may not transmit another DCI 615c scheduling another transport block associated with the same HARQ identifier 620 and the NDI 625b, which may be different from the NDI 625a, for a long time. In the example 600, if the UE 120 was unable to detect or report the unsuccessful termination of the HARQ process associated with the transport block 630 until the UE 120 received the DCI 615c, additional latency may be introduced due to the network node 110 initiating an ARQ process to retransmit one or more RLC SDUs or RLC SDU segments associated with the transport block 630. In another example, the UE 120 may fail to receive or decode the DCI 615c scheduling the other transport block with the same HARQ identifier 620 as the transport block 630. Here, the UE 120 may fail to identify the unsuccessful termination of the HARQ process associated with the transport block 630 without the timer.

While the example 600 may support timer-based reporting of unsuccessful HARQ termination for decreased ARQ latency, in other cases (such when the UE 120 transmits a HARQ ACK indication for a given transport block associated with a HARQ process as depicted in the second event 510 and the third event 515 of FIG. 5), the UE 120 may be unaware of whether a subsequent DCI is expected. Therefore, the UE 120 may still experience the increased ARQ latency for reporting unsuccessful termination of the HARQ processes in cases where the UE 120 transmits a HARQ ACK indication for a given transport block.

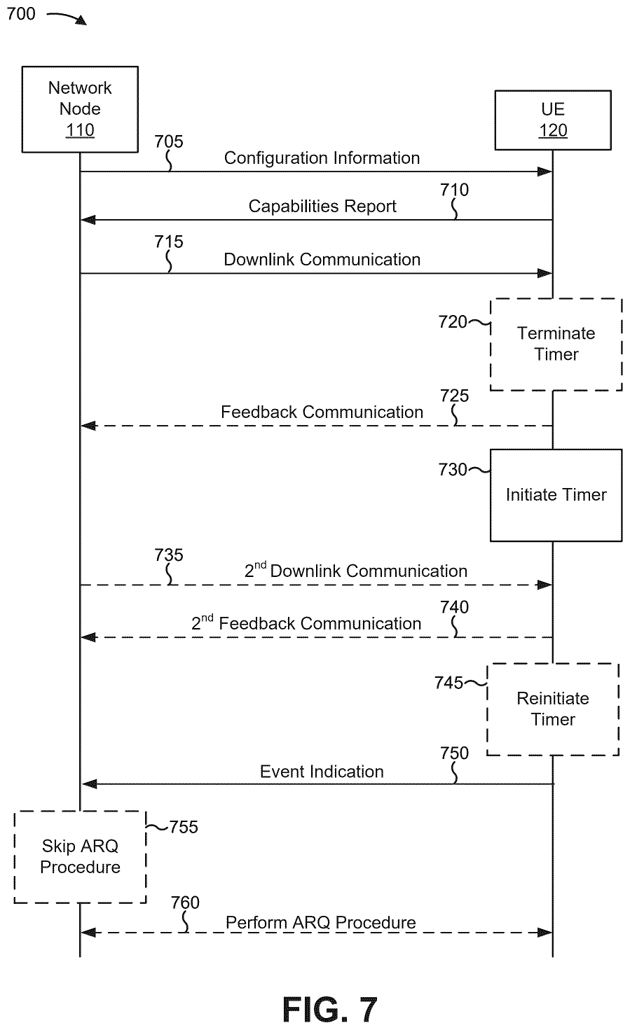

FIG. 7 is a diagram of an example 700 associated with feedback identifier reporting, in accordance with the present disclosure. As shown in FIG. 7, a network node 110 (e.g., network node 110 of FIGS. 1-3, a CU, a DU, and/or an RU) may communicate with a UE (e.g., UE 120 of FIGS. 1-3). In some aspects, the network node 110 and the UE 120 may be part of a wireless communication network 100 (e.g., wireless communication network 100 of FIG. 1). The UE 120 and the network node 110 may have established a wireless connection prior to operations shown in FIG. 7.

As shown by reference number 705, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC-CEs and/or one or more DCI messages, among other examples.

In some aspects, the configuration information may configure one or more timers for triggering a report transmission for the UE 120 indicating the unsuccessful termination (e.g., potentially unsuccessful termination) of a HARQ process. For example, the UE 120 may receive configuration information indicating a value of a timer associated with a HARQ process identifier. In some aspects, receiving the configuration information may include receiving RRC signaling indicating the value of the timer.

In some aspects, the configuration information may indicate that the value of the timer is to be associated with the HARQ process identifier, a component carrier of a downlink communication (e.g., including control information, data information, and/or feedback information, or a component carrier group of the downlink communication). For example, the value of the timer may be configured (e.g., RRC configured) per component carrier and/or per HARQ ID. Thus, HARQ processes occurring via a first component carrier and/or component carrier group may be subject to a different timer value for reporting unsuccessful HARQ terminations than HARQ processes occurring via a second component carrier and/or component carrier group. Additionally, or alternatively, HARQ processes associated with a first HARQ identifier may be subject to a different timer value for reporting unsuccessful HARQ terminations than HARQ processes associated with a first HARQ identifier. The network node 110 may transmit configuration information indicating a value of the timer according to a scheduler of the network node which may influence the value of the time according to a quality of service requirement and/or a traffic type (e.g., either of which may correspond to a component carrier, a component cattier group, and/or a HARQ ID). For example, HARQ identifiers may be reused, but a frequency of may depend on the scheduler of the network node 110 (e.g., may depend on a quality of service requirement of a transport block and/or a traffic type of the transport block).

In some aspects, the UE 120 may receive configuration information indicating a first value of the timer associated with ACK indications and a second value of the timer associated with NACK indications. For example, the configuration information may specify two values of the timer, one for ACK feedback and one for NACK feedback. The UE 120 may set a value of the timer to either the first value or the second value depending on, or otherwise based on or associated with whether HARQ feedback for a particular transport block includes an ACK or a NACK.

In some other aspects, the configuration information may indicate that the timer includes a first timer and a second timer. Additionally or alternatively, the configuration information may indicate a first value for the first timer and a second value for the second timer. In such aspects, the first timer (e.g., and the first value) may be associated with ACK indications and the second timer (e.g., and the second value) may associated with NACK indications. For example, the configuration information may include multiple (e.g., separate) configurations for the two timers because the duration that a HARQ identifier is not used (e.g., triggering an event indication) may be different when a previously occurring transport block is decoded (e.g., successfully decoded) than when a previously occurring transport block is undecoded (e.g., unsuccessfully decoded). In some aspects, the configuration information may indicate that the UE 120 is to associated the first value and/or the second value with the HARQ process identifier, a component carrier of the downlink communication, and/or a component carrier group for the downlink communication (e.g., including control information, data information, and/or feedback information). In some aspects, even if the values of the first and/or second timers are same for a plurality of HARQ identifiers and/or for a single HARQ identifier (e.g., if RRC-configured per component carrier and/or component carrier group), each timer may be maintained separately per HARQ identifier.

The UE 120 may configure itself based at least in part on the configuration information. In some aspects, the UE 120 may be configured to perform one or more operations described herein based at least in part on the configuration information.

As shown by reference number 710, the UE 120 may transmit, and the network node 110 may receive, a capabilities report. The capabilities report may indicate whether the UE 120 supports a feature and/or one or more parameters related to the feature. For example, the capability information may indicate a capability and/or parameter for detecting and/or reporting unsuccessful HARQ termination(s) and/or unused feedback (e.g., HARQ feedback) identifier reporting. As another example, the capabilities report may indicate a capability and/or parameter for implementing one or more aspects related to a timer associated with the HARQ process identifier. One or more operations described herein may be based on capability information of the capabilities report. For example, the UE 120 may perform a communication in accordance with the capability information, or may receive configuration information that is in accordance with the capability information. In some aspects, the capabilities report may indicate that the UE 120 supports detecting and/or reporting unsuccessful HARQ termination(s) and/or unused feedback (e.g., HARQ feedback) identifier reporting using multiple timers and/or timer values. Additionally, or alternatively, the capabilities report may indicate that the UE 120 supports indicating one or more criteria associated with the timer(s), the initiation of the timer(s), the termination of the timer(s), a type of HARQ feedback associated with the timer(s), among other aspects. For example, the capabilities report may indicate whether the UE 120 is capable of formatting an event indication (e.g., unsuccessful HARQ termination report, feedback error) with additional information related to the timer(s).

In some aspects, the configuration information described in connection with reference number 705 and/or the capabilities report described in connection with reference number 710 may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

As shown by reference number 715, the network node 110 may transmit, and the UE 120 may receive, a downlink communication. For example, the UE 120 may receive a downlink communication associated with a HARQ process identifier (e.g., feedback identifier). In such examples, the downlink communication may include control information (e.g., DCI) scheduling a data message (e.g., transport block, PDSCH), and/or may include the data message. The downlink communication may include multiple downlink messages.

As shown by reference number 730, the UE 120 may initiate a timer. For example, the UE 120 may initiate a timer associated with the HARQ process identifier in accordance with the downlink communication or in accordance with a feedback communication associated with the downlink communication. In some aspects, the UE 120 may initiate the timer in response to receiving and/or decoding the downlink communication. Additionally or alternatively, the UE 120 may initiate the timer in response to transmitting a feedback communication (e.g., HARQ feedback) associated with the downlink communication. In some aspects, the UE 120 may initiate the timer according to a first value (e.g., duration) in response to transmitting an ACK indication associated with the downlink communication. In some other aspects, the UE 120 may initiate the timer according to a second value (e.g., duration) in response to transmitting a NACK indication associated with the downlink communication. The transmission of the feedback communication will be described in further detail in connection with reference number 725.

In some aspects, the UE 120 may initiate the timer in response to receiving control information associated with the downlink communication and/or in response to receiving the downlink communication. In a first example, the UE 120 may initiate and/or reinitiate (e.g., after expiration and/or termination) the timer relative to a control information message (e.g., DCI). The UE 120 may receive and/or decode control information that schedules the downlink communication (e.g., transport block and/or PDSCH) and may start (e.g., initiate, reinitiate, and/or restart) the timer in response to, or otherwise based on, receiving and/or decoding the downlink control information. In a second example, the UE 120 may initiate and/or reinitiate (e.g., after expiration and/or termination) the timer relative to the downlink communication (as described in connection with reference number 715). The UE 120 may receive and/or decode the downlink communication (e.g., transport block and/or PDSCH) and may start (e.g., initiate, reinitiate, and/or restart) the timer in response to, or otherwise based on, receiving and/or decoding the downlink communication.

In some aspects, the UE 120 may initiate the timer based on transmitting HARQ feedback. For example, as shown by reference number 725, the UE 120 may transmit, and the network node 110 may receive, a feedback communication. The feedback communication may be associated with the downlink communication (e.g., transport block, PDSCH) and may include an ACK indicating the downlink communication was successfully decoded and/or a NACK indication indicating the downlink communication was associated with a decoding error. In such aspects, the UE 120 may initiate the timer described in connection with reference number 730 based on (e.g., in response to, after) transmitting the feedback communication. In some aspects, initiating the timer based on (e.g., in response to, after) transmitting the feedback communication may include reinitiating the timer. For example, as shown by reference number 720, the UE 120 may terminate the timer in response to receiving control information associated with the downlink communication. In such aspects, initiating the timer after transmitting the feedback communication may include reinitiating the timer after transmitting the feedback communication associated with receiving the downlink communication.

For example, the UE 120 may start and/or restart the timer with respect to the end of the associated HARQ feedback transmission (e.g., irrespective of whether the feedback transmission includes ACK and/or NACK). In some aspects, the UE 120 may additionally stop and/or reset the timer (e.g., if it was previously initiated) in response to (e.g., from the end of) a DCI and/or a PDSCH associated with the given HARQ ID prior to starting and/or restarting the timer with respect to the end of the associated HARQ feedback transmission. Doing so may prevent the previously initiated timer from expiring (and thus triggering an event indication) during the duration between communicating the DCI and/or the transport block (e.g., PDSCH) and communicating the HARQ feedback.

In some aspects, as described in connection with reference number 705, the UE 120 may be configured with two timers, a first timer associated with ACK indications and a second timer associated with NACK indication. In some aspects, each of the first timer and the second timer may be associated with the HARQ process identifier. In such aspects, the UE 120 may initiate the first timer and/or the second timer. For example, the UE 120 may transmit the feedback communication, described in connection with reference number 725, including an ACK indication. In such aspects, the UE 120 may initiate the timer by initiating the first timer having the first value. In some other aspects, the UE 120 may transmit the feedback communication, described in connection with reference number 725, including a NACK indication. In such aspects, the UE 120 may initiate the timer by initiating the second timer having the second value.

In some aspects, the UE 120 initiating the timer associated with the HARQ process identifier may include initiating a second instance of the first timer and/or the second timer. For example, as shown by reference number 720, the UE 120 may terminate a first instance of the first timer and/or the second timer in response to receiving control information associated with the downlink communication, and/or the downlink communication, described in connection with reference number 715. In such aspects, as shown by reference number 725, the UE 120 may transmit, and the network node 110 may receive, the feedback communication, for example, including a NACK indication and/or an ACK indication, associated with the downlink communication. Thus, initiating the timer, as described in connection with reference number 730, associated with the HARQ process identifier may include initiating a second instance of the first timer and/or the second timer (e.g., in response to transmitting the feedback communication). For example, the UE 120 may stop and/or reset the first timer and/or the second timer with respect to the end of a DCI and/or a PDSCH associated with the given HARQ ID (e.g., in case of the feedback communication including either of an ACK indication and/or a NACK indication).

As shown by reference number 750, the UE 120 may transmit, and the network node 110 may receive, an event indication. For example, the UE 120 may transmit, to the network node 110, an indication of an event associated with the HARQ process identifier in association with the expiration of the timer and/or the expiration of the first timer and/or the second timer (e.g., having the first value (e.g., duration) or the second value (e.g., duration), respectively). The event indication may include one or more indications, such as the HARQ process identifier, an NDI associated with the downlink communication, an indication of a component carrier and/or a component carrier group associated with receiving the downlink communication, an indication of whether the feedback communication, in accordance with initiating the timer, included an ACK indication and/or a NACK indication, a time stamp indicating when the expiration of the timer occurred, and/or a time stamp indicating when initiation of the timer occurred. In some examples, the one or more indications to be included in the event indication may be configured by the configuration information described in connection with reference number 705.

In some aspects, the indication of the event may indicate that the HARQ process identifier was unassociated with a second downlink communication occurring after the timer was initiated and before the expiration of the timer. For example, the indication of the event may indicate that the HARQ process identifier was unused (e.g., with respect to the UE 120 receiving a transport block associated with the HARQ process identifier) in the intervening time between the UE 120 initiating the timer (described in connection with reference number 730) and the expiration of the timer. In such aspects, the network node 110 may identify, according to the event indication, that no downlink communication was communicated during this time. Thus, as shown by reference number 755, the network node 110 may skip an ARQ procedure. In some other aspects, the network node 110 may identify, according to the event indication, that a downlink communication was transmitted and/or scheduled but was associated with a reception error. Thus, as shown by reference number 760, the network node 110 and/or the UE 120, may perform an ARQ procedure. For example, the network node 110 may retransmit the downlink communication associated with the reception error as part of the ARQ procedure, among other aspects.

In some aspects, the UE 120 transmitting the indication of the timer as described in connection with reference number 750 may include transmitting the indication of the event after a reinitiation of the timer. For example, as shown by reference number 735, the network node 110 may transmit, and the UE 120 may receive, a second downlink communication. In some aspects, the second downlink communication may be associated with the HARQ process identifier (e.g., the same HARQ process identifier associated with the downlink communication shown by reference number 715). In such aspects, as shown by reference number 745, the UE 120 may reinitiate the timer. For example, the UE 120 may reinitiate the timer associated with the HARQ process identifier in accordance with receiving the second downlink communication. In some aspects, as shown by reference number 740, the UE 120 may transmit, and the network node 110 may receive, a second feedback communication associated with the second downlink communication. Thus, in some other aspects, the UE 120 may reinitiate the timer associated with the HARQ process identifier in accordance with transmitting the second feedback communication associated with the second downlink communication. The UE 120 may transmit the event indication in response to the reinitiated timer expiring (e.g., running out of time, the value and/or duration of the reinitiated timer occurring). In such aspects, the network node 110 may determine to skip an ARQ procedure, as described in connection with reference number 755, and/or perform an ARQ procedure, as described in connection with reference number 760.

As shown by reference number 755, the network node 110 may skip performing an ARQ procedure. For example, the network node 110 may receive the feedback communication, described in connection with reference number 725, including an acknowledgement indication. In such examples, the indication of the event, described in connection with reference number 750, includes an indication that the expiration of the timer is relative to the feedback communication. The network node 110 may refrain from performing an ARQ procedure in accordance with the indication that the expiration of the timer is relative to the feedback communication. For example, the network node 110 may identify that the HARQ ID was unused (e.g., the network node 110 did not transmit and/or schedule a downlink communication associated with the HARQ process identifier) during the timer following the ACK indication. Therefore, the network node 110 may determine to skip the ARQ procedure because the network node 110 did not schedule any TB and/or PDSCH associated with the HARQ process ID. Skipping the ARQ procedure based on receiving the event indication may reduce overhead that would otherwise be used for initiating and/or triggering an ARQ procedure unnecessarily.

In some other examples, as shown by reference number 760, the network node 110 may determine to perform an ARQ procedure with the UE 120 in accordance with the indication that the expiration of the timer is relative to the feedback communication. For example, the network node 110 may transmit and/or schedule via control information, before the expiration of the timer, a second downlink communication associated with the HARQ process ID as described in connection with reference number 740. Therefore, the network node 110 may determine to perform the ARQ procedure for the second downlink communication because the network node 110 may identify that the initial transmission of the second downlink communication was associated with a decoding error based on the indication that the expiration of the timer is relative to the feedback communication.

Performing the ARQ procedure based on receiving the event indication may reduce ARQ latency that would otherwise occur if the UE 120 was to wait until receiving a subsequent control information message to initiate and/or trigger an ARQ procedure.

As indicated above, FIG. 7 is provided as an example. Other examples may differ from what is described with respect to FIG. 7.

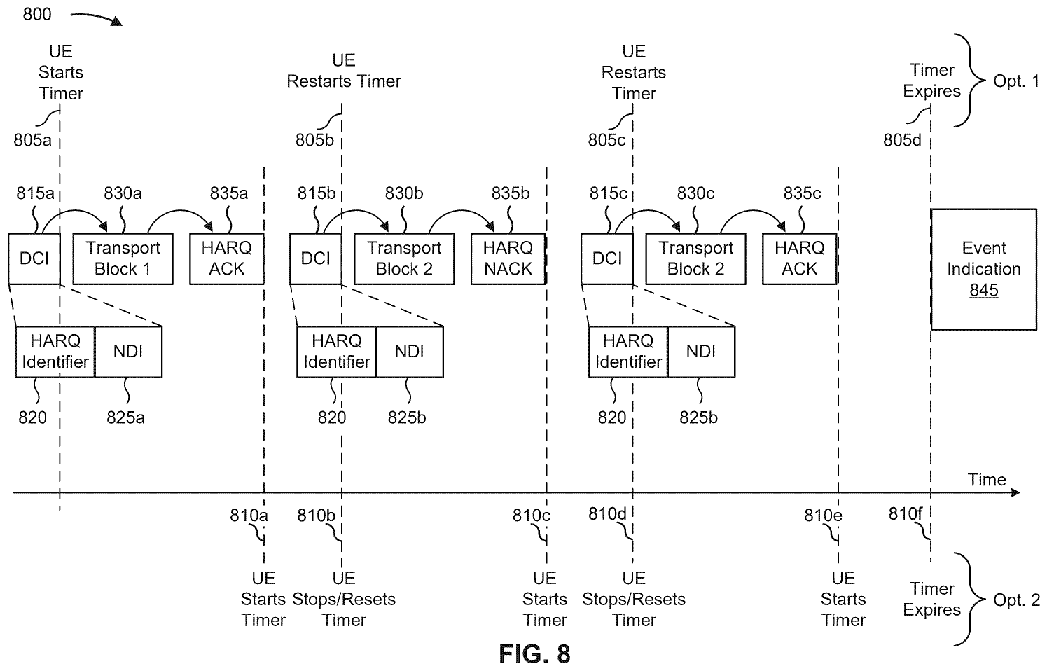

FIG. 8 is a diagram illustrating an example 800 of signaling exchanged between a transmitting and receiving device (for example, between a network node 110 and a UE 120), in accordance with the present disclosure.

FIG. 8 illustrates an example where the network node 110 configures a timer associated with the UE 120 identifying unsuccessful terminations of HARQ processes, for example, as related to second event 510 and/or third event 515 of FIG. 5. In particular, the network node 110 may indicate (for example, via the configuration information described in connection with reference number 705 of FIG. 7) for the UE 120 to identify an unsuccessful HARQ process termination in response to an expiration of a timer. In particular, the UE 120 may start the timer in response to the communication and/or decoding of DCI 815 scheduling a transport block 830 in a first timer option. Additionally, or alternatively, the UE 120 may start the timer in response to transmitting HARQ feedback 835 for a transport block 830 in a second timer option. If the timer expires prior to the UE 120 detecting a retransmission associated with the transport block 830 or prior to the UE 120 detecting a DCI 815 scheduling a new transport block associated with the same HARQ identifier 820 (such as a DCI 815 indicating the same HARQ identifier 820 but a different NDI 825), the UE 120 may identify an unsuccessful termination of the HARQ process associated with the transport block 830.

The network node 110 may transmit signaling to the UE 120 configuring a value for the timer. For example, the network node 110 may transmit (for example, via RRC signaling, via the configuration information described in connection with reference number 705 of FIG. 7) signaling indicating the value for the timer.

In a first timer option (shown as Opt. 1) of the example 800, the DCI 815a may schedule an initial transmission of the transport block 830a, and may indicate that the transport block 830a is associated with the HARQ identifier 820 and an NDI 825a. The UE 120 may initiate the timer at time 805a (e.g., relative to the occurrence (e.g., beginning, end, initiation of decoding, completion of decoding) of the DCI 815a). The UE 120 may successfully decode the initial transmission of the transport block 830a, and may transmit a HARQ ACK 835a to the network node 110. The network node 110 may schedule an initial transmission of the transport block 830b (for example, via the DCI 815b which indicates the same HARQ identifier 820 as the initial transmission of the transport block 830a and a second NDI 825b). Additionally, if the UE 120 receives a DCI 815b that indicates a same HARQ identifier 820 (for example, with the same or different NDI 825), the UE 120 may stop and reset the timer. Therefore, at time 805b, the UE 120 may start or restart (e.g., initiate or re-initiate) the timer based on the DCI 815b indicating the same HARQ identifier 820 as the DCI 815a. In the first timer option of the example 800, the UE 120 receives the DCI 815b scheduling the retransmission of the transport block 830b prior to the expiration of the timer.

However, the UE 120 may be unable to successfully decode the initial transmission of the transport block 830b, and may transmit a HARQ NACK 835b to the network node 110. The network node 110 may schedule a retransmission of the second transport block 830c (for example, via the DCI 815c which indicates the same HARQ identifier 820 and NDI 825b as the initial transmission of the second transport block 830b). Additionally, if the UE 120 receives a DCI 815c that indicates a same HARQ identifier 820 (for example, with the same or different NDI 825), the UE 120 may start/restart the timer. Therefore, at time 805c, the UE 120 may start/restart the timer based on the DCI 815c indicating the same HARQ identifier 820 as the DCI 815b. In the first timer option of the example 800, the UE 120 receives the DCI 815c scheduling the retransmission of the second transport block 830c prior to the expiration of the timer.

Accordingly, the UE 120 does not detect an unsuccessful termination of the HARQ process associated with the transport block 830 between times 805a and 805b and/or between times 805b and 805c.

In the first timer option of the example 800, the UE 120 is able to successfully decode the second transport block using a combination of the initial transmission of the second transport block 830b and the retransmission of the second transport block 830c. Accordingly, the UE 120 transmits another HARQ ACK 835c associated with the second transport block.

At time 805d, the timer may expire. In response to the timer expiring prior to the UE 120 detecting a subsequent DCI 815 (for example, a DCI 815 scheduling a new transmission (e.g., having an NDI different from NDI 825) associated with the HARQ identifier 820), the UE 120 may identify an unsuccessful HARQ process termination associated with the transport block 830 and the HARQ identifier 820. Accordingly, the UE 120 may transmit an event indication 845 (e.g., an unsuccessful HARQ process termination indication) to the network node 110.

In some cases, the network node 110 configuring the UE 120 to identify unsuccessful HARQ process terminations in response to an expiration of a timer may decrease a latency associated with the UE 120 detecting and reporting unsuccessful HARQ process terminations. For example, the network node 110 may not transmit an additional DCI 815 scheduling another transport block associated with the same HARQ identifier 820 and the NDI 825b, which may be different from the NDI 825a, for a long time. In the first timer option of example 800, if the UE 120 was unable to detect or report the unsuccessful termination of the HARQ process associated with the transport block 830 until the UE 120 received the DCI 815, additional latency may be introduced due to the network node 110 initiating an ARQ process to retransmit one or more RLC SDUs or RLC SDU segments associated with the transport block 830. In another example, the UE 120 may fail to receive or decode the additional DCI 815 scheduling the other transport block with the same HARQ identifier 820 as the transport block 830. In such examples, the UE 120 may fail to identify the unsuccessful termination of the HARQ process associated with the transport block 830 without the timer.

In a second timer option (shown as Opt. 2) of the example 800, the DCI 815a may schedule an initial transmission of a first transport block 830a, and may indicate that the transport block 830a is associated with the HARQ identifier 820 and an NDI 825a. The UE 120 may decode the initial transmission of the transport block 830a, and may transmit a HARQ ACK 835a to the network node 110 and start (for example, initiate) the timer at time 810a, relative to the HARQ ACK 835a. At time 810b, the network node 110 may schedule an initial transmission of the transport block 830b (for example, via the DCI 815b which indicates the same HARQ identifier 820 as the initial transmission of the transport block 830a and an NDI 825b). Additionally, if the UE 120 receives a DCI 815b that indicates a same HARQ identifier 820 (for example, with the same or different NDI 825), the UE 120 may stop and reset the timer. Therefore, at time 810b, the UE 120 may stop and reset the timer based on the DCI 815b indicating the same HARQ identifier 820 as the DCI 815a. In the second timer option of example 800, the UE 120 receives the DCI 815b scheduling the initial transmission of the second transport block 830b prior to the expiration of the timer.

However, the UE 120 may be unable to successfully decode the initial transmission of the second transport block 830b, and may transmit a HARQ NACK 835b to the network node 110 and start (for example, initiate) the timer at time 810c, relative to the HARQ NACK 835b. At time 810d, the network node 110 may schedule a retransmission of the second transport block 830c (for example, via the DCI 815c which indicates the same HARQ identifier 820 and NDI 825b as the initial transmission of the second transport block transport block 830b). Additionally, if the UE 120 receives a DCI 815c that indicates a same HARQ identifier 820 (for example, with the same or different NDI 825), the UE 120 may stop and reset the timer. Therefore, at time 810d, the UE 120 may restart (e.g., stop and reset) the timer based on the DCI 815c indicating the same HARQ identifier 820 as the DCI 815b. In the second timer option of example 800, the UE 120 receives the DCI 815c scheduling the retransmission of the second transport block 830c prior to the expiration of the timer.

Accordingly, the UE 120 does not detect an unsuccessful termination of the HARQ process associated with the transport block 830 between times 810a and 810b and/or between times 810c and 810d.

In the second timer option of example 800, the UE 120 is able to successfully decode the second transport block using a combination of the initial transmission of the second transport block 830b and the retransmission of the second transport block 830c. Accordingly, the UE 120 transmits another HARQ ACK 835c associated with the second transport block and starts (for example, initiate) the timer at time 810e, relative to the HARQ ACK 835c.

At time 810f, the timer may expire. In response to the timer expiring prior to the UE 120 detecting any downlink control information 815 scheduling another retransmission associated with a transport block 830, the UE 120 may identify an unsuccessful HARQ process termination associated with the transport block 830 and the HARQ identifier 820. Accordingly, the UE 120 may transmit an event indication 845 (e.g., an unsuccessful HARQ process termination indication) to the network node 110.

In some cases, the network node 110 configuring the UE 120 to identify unsuccessful HARQ process terminations in response to an expiration of a timer may decrease a latency associated with the UE 120 detecting and reporting unsuccessful HARQ process terminations. For example, the network node 110 may not transmit an additional DCI 815 scheduling another transport block associated with the same HARQ identifier 820 and the NDI 825b, which may be different from the NDI 825a, for a long time. In the second timer option of example 800, if the UE 120 was unable to detect or report the unsuccessful termination of the HARQ process associated with the transport block 830 until the UE 120 received the DCI 815, additional latency may be introduced due to the network node 110 initiating an ARQ process to retransmit one or more RLC SDUs or RLC SDU segments associated with the transport block 830. In another example, the UE 120 may fail to receive or decode the additional DCI 815 scheduling the other transport block with the same HARQ identifier 820 as the transport block 830. In such examples, the UE 120 may fail to identify the unsuccessful termination of the HARQ process associated with the transport block 830 without the timer.

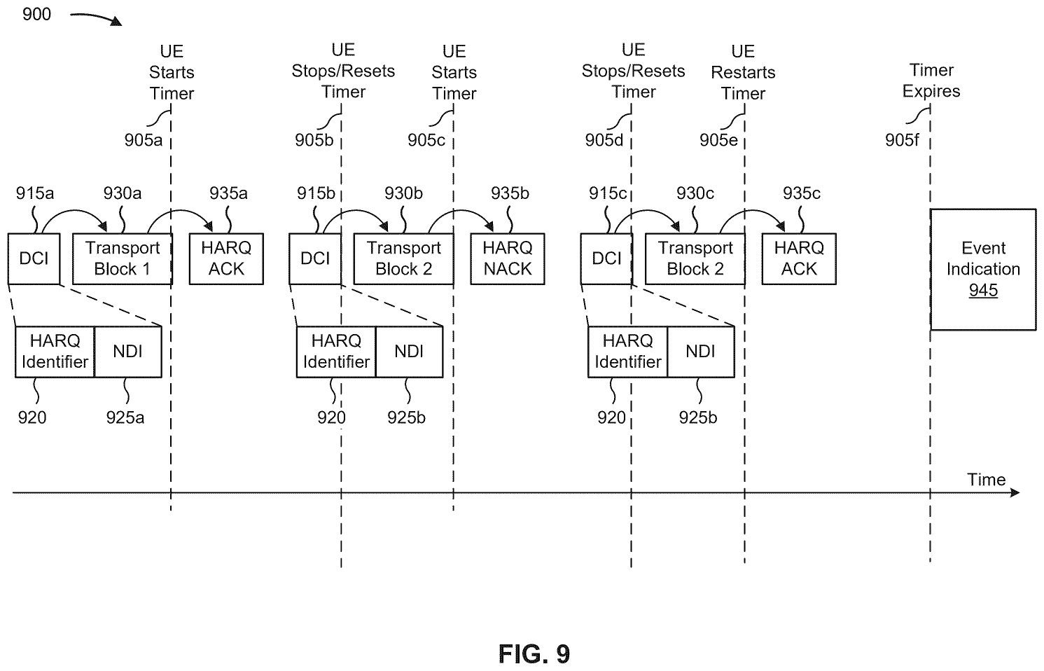

FIG. 9 is a diagram illustrating an example 900 of signaling exchanged between a transmitting and receiving device (for example, between a network node 110 and a UE 120), in accordance with the present disclosure.

FIG. 9 illustrates an example where the network node 110 configures a timer associated with the UE 120 identifying unsuccessful terminations of HARQ processes, for example, as related to second event 510 and/or third event 515 of FIG. 5. In particular, the network node 110 may indicate (for example, via the configuration information described in connection with reference number 705 of FIG. 7) for the UE 120 to identify an unsuccessful HARQ process termination in response to an expiration of a timer. In particular, the UE 120 may start the timer in response to the communication of and/or decoding of a transport block 930. If the timer expires prior to the UE 120 detecting a retransmission associated with the transport block 930 or prior to the UE 120 detecting a DCI 915 scheduling a new transport block associated with the same HARQ identifier 920 (such as a DCI 915 indicating the same HARQ identifier 920 but a different NDI 925), the UE 120 may identify an unsuccessful termination of the HARQ process associated with the transport block 930.

The network node 110 may transmit signaling to the UE 120 configuring a value for the timer. For example, the network node 110 may transmit (for example, via RRC signaling, via the configuration information described in connection with reference number 705 of FIG. 7) signaling indicating the value for the timer.

In the example 900, the DCI 915a may schedule an initial transmission of a first transport block 930a, and may indicate that the transport block 930a is associated with the HARQ identifier 920 and an NDI 925a. The UE 120 may decode the initial transmission of the transport block 930a, and may transmit a HARQ ACK 935a to the network node 110. The UE 120 may start (for example, initiate) the timer at time 905a, relative to the transport block 930a. At time 905b, the network node 110 may schedule an initial transmission of the second transport block 930b (for example, via the DCI 915b which indicates the same HARQ identifier 820 as the initial transmission of the transport block 930a and an NDI 925b). Additionally, if the UE 120 receives a DCI 915b that indicates a same HARQ identifier 920 (for example, with the same or different NDI 925), the UE 120 may stop and reset the timer. Therefore, at time 905b, the UE 120 may stop and reset the timer (e.g., relative to the occurrence of DCI 915b) based on the DCI 915b indicating the same HARQ identifier 920 as the DCI 915a. In the example 900, the UE 120 receives the DCI 915b scheduling the initial transmission of the second transport block 930b prior to the expiration of the timer.

However, the UE 120 may be unable to successfully decode the initial transmission of the second transport block 930b, and may initiate the timer at time 905c, relative to the occurrence of the transport block 930b. The UE 120 may transmit a HARQ NACK 935b to the network node 110. At time 905d, the network node 110 may schedule a retransmission of the second transport block 930c (for example, via the DCI 915c which indicates the same HARQ identifier 920 and NDI 925b as the initial transmission of the second transport block transport block 830b). Additionally, if the UE 120 receives a DCI 915c that indicates a same HARQ identifier 920 (for example, with the same or different NDI 925), the UE 120 may stop and reset the timer.

Therefore, at time 905d, the UE 120 may restart (e.g., stop and reset) the timer based on the DCI 915c indicating the same HARQ identifier 920 as the DCI 915b. In the example 900, the UE 120 receives the DCI 915c scheduling the retransmission of the second transport block 930c prior to the expiration of the timer.

Accordingly, the UE 120 does not detect an unsuccessful termination of the HARQ process associated with the transport block 930 between times 905a and 905b and/or between times 905c and 905d.

In the example 900, the UE 120 is able to successfully decode the second transport block using a combination of the initial transmission of the second transport block 930b and the retransmission of the second transport block 930c. Accordingly, the UE 120 starts (for example, initiates) the timer at time 905e, relative to the transport block 930c and transmits another HARQ ACK 935c associated with the second transport block.

At time 905f, the timer may expire. In response to the timer expiring prior to the UE 120 detecting any downlink control information 915 scheduling another retransmission associated with a transport block 930, the UE 120 may identify an unsuccessful HARQ process termination associated with the transport block 930 and the HARQ identifier 920. Accordingly, the UE 120 may transmit an event indication 945 (e.g., an unsuccessful HARQ process termination indication) to the network node 110.

In some cases, the network node 110 configuring the UE 120 to identify unsuccessful HARQ process terminations in response to an expiration of a timer may decrease a latency associated with the UE 120 detecting and reporting unsuccessful HARQ process terminations. For example, the network node 110 may not transmit an additional DCI 915 scheduling another transport block associated with the same HARQ identifier 920 and the NDI 925b, which may be different from the NDI 925a, for a long time. In the second timer option of example 900, if the UE 120 was unable to detect or report the unsuccessful termination of the HARQ process associated with the transport block 930 until the UE 120 received the DCI 915, additional latency may be introduced due to the network node 110 initiating an ARQ process to retransmit one or more RLC SDUs or RLC SDU segments associated with the transport block 930. In another example, the UE 120 may fail to receive or decode the additional DCI 915 scheduling the other transport block with the same HARQ identifier 920 as the transport block 930. In such examples, the UE 120 may fail to identify the unsuccessful termination of the HARQ process associated with the transport block 930 without the timer.

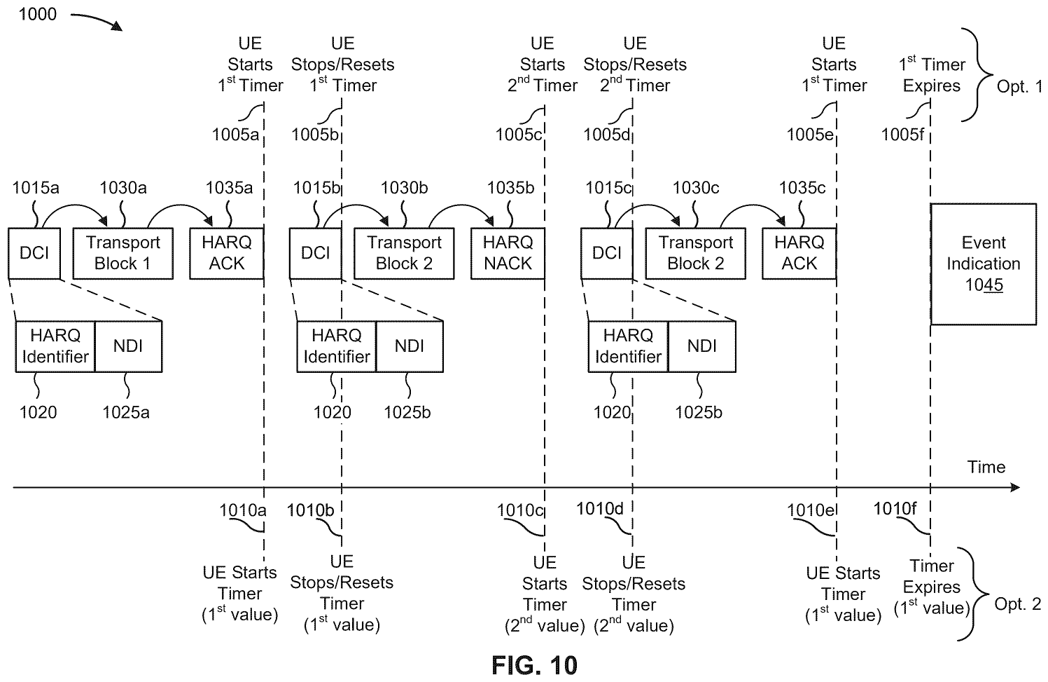

FIG. 10 is a diagram illustrating an example 1000 of signaling exchanged between a transmitting and receiving device (for example, between a network node 110 and a UE 120), in accordance with the present disclosure.

FIG. 10 illustrates an example where the network node 110 configures one or more timers associated with the UE 120 identifying unsuccessful terminations of HARQ processes, for example, as related to second event 510 and/or third event 515 of FIG. 5. In particular, the network node 110 may indicate (for example, via the configuration information described in connection with reference number 705 of FIG. 7) for the UE 120 to identify an unsuccessful HARQ process termination in response to an expiration of a first timer, a second timer, and/or a timer configured with two values. In particular, the UE 120 may start the first timer and/or the timer having the first value in response to the communication of HARQ feedback 1035 including an ACK indication.

Additionally, or alternatively, the UE 120 may start the second timer and/or the timer having the second value in response to the communication of HARQ feedback 1035 including a NACK indication. In such examples, both the first timer and the second timer may be associated with the HARQ identifier. If the timer expires prior to the UE 120 detecting a retransmission associated with the transport block 1030 or prior to the UE 120 detecting a DCI 1015 scheduling a new transport block associated with the same HARQ identifier 1020 (such as a DCI 1015 indicating the same HARQ identifier 1020 but a different NDI 1025), the UE 120 may identify an unsuccessful termination of the HARQ process associated with the transport block 1030.

In a first timer option (shown as Opt. 1) of example 1000, the network node 110 may transmit signaling to the UE 120 configuring two timers. For example, the network node 110 may transmit (for example, via RRC signaling, via the configuration information described in connection with reference number 705 of FIG. 7) signaling indicating a first value for the first timer and a second value for the second timer.

In the first timer option, the DCI 1015a may schedule an initial transmission of the transport block 1030a, and may indicate that the transport block 1030a is associated with the HARQ identifier 1020 and an NDI 1025a. The UE 120 may successfully decode the initial transmission of the transport block 1030a, and may transmit a HARQ ACK 1035a to the network node 110 and start (for example, initiate) the first timer at time 1005a, relative to the HARQ ACK 1035a. At time 1005b, the network node 110 may schedule an initial transmission of the transport block 1030b (for example, via the DCI 1015b which indicates the same HARQ identifier 1020 as the initial transmission of the transport block 1030a and a second NDI 1025b). Additionally, if the UE 120 receives a DCI 1015b that indicates a same HARQ identifier 1020 (for example, with the same or different NDI 1025), the UE 120 may stop and reset the first timer, relative to the occurrence of the DCI 1015b. Therefore, at time 1005b, the UE 120 may stop and reset the first timer based on the DCI 1015b indicating the same HARQ identifier 1020 as the DCI 1015a. In some other examples, stopping and resetting the first timer at time 1005b may occur relative to the communication and/or the attempted decoding of the transport block 1030b. In the first timer option of the example 1000, the UE 120 receives the DCI 1015b scheduling the retransmission of the transport block 1030b prior to the expiration of the first timer.

However, the UE 120 may be unable to successfully decode the initial transmission of the transport block 1030b, and may transmit a HARQ NACK 1035b to the network node 110 and start (for example, initiate) the second timer having the second value at time 1005c, relative to the HARQ NACK 1035b. The network node 110 may schedule a retransmission of the second transport block 1030c (for example, via the DCI 1015c which indicates the same HARQ identifier 1020 and NDI 1025b as the initial transmission of the second transport block 1030b). Additionally, if the UE 120 receives a DCI 1015c that indicates a same HARQ identifier 1020 (for example, with the same or different NDI 1025), the UE 120 may stop and reset the second timer at time 1005d. Therefore, at time 1005d, the UE 120 may stop and reset the second timer relative to the occurrence of, or otherwise based on the DCI 1015c indicating the same HARQ identifier 1020 as the DCI 1015b. In some other examples, stopping and resetting the first timer at time 1005d may occur relative to the communication and/or the attempted decoding of the transport block 1030c. In the first timer option of the example 1000, the UE 120 receives the DCI 1015c scheduling the retransmission of the second transport block 1030c prior to the expiration of the second timer.

Accordingly, the UE 120 does not detect an unsuccessful termination of the HARQ process associated with the transport block 1030 between times 1005a and 1005b and/or between times 1005c and 1005d.

In the first timer option of the example 1000, the UE 120 is able to successfully decode the second transport block using a combination of the initial transmission of the second transport block 1030b and the retransmission of the second transport block 1030c. Accordingly, the UE 120 transmits another HARQ ACK 1035c associated with the second transport block and starts (for example, initiates) the first timer at time 1005e, relative to the HARQ ACK 1035c.

At time 1005f, the first timer (e.g., having the first value and/or a first duration) may expire. In response to the first timer expiring prior to the UE 120 detecting any control information 1015 scheduling another retransmission associated with a transport block 1030, the UE 120 may identify an unsuccessful HARQ process termination associated with the transport block 1030 and the HARQ identifier 1020. Accordingly, the UE 120 may transmit an event indication 1045 (e.g., an unsuccessful HARQ process termination indication) to the network node 110.

In some cases, the network node 110 configuring the UE 120 to identify unsuccessful HARQ process terminations in response to an expiration of the first and/or second timer may decrease a latency associated with the UE 120 detecting and reporting unsuccessful HARQ process terminations. For example, the network node 110 may not transmit an additional DCI 1015 scheduling another transport block associated with the same HARQ identifier 1020 and the NDI 1025b, which may be different from the NDI 1025a, for a long time. In the first timer option of example 1000, if the UE 120 was unable to detect or report the unsuccessful termination of the HARQ process associated with the transport block 1030 until the UE 120 received the DCI 1015, additional latency may be introduced due to the network node 110 initiating an ARQ process to retransmit one or more RLC SDUs or RLC SDU segments associated with the transport block 1030. In another example, the UE 120 may fail to receive or decode the additional DCI 1015 scheduling the other transport block with the same HARQ identifier 1020 as the transport block 1030. In such examples, the UE 120 may fail to identify the unsuccessful termination of the HARQ process associated with the transport block 1030 without the first and/or second timer.

In a second timer option (shown as Opt. 2) of example 1000, the network node 110 may transmit signaling to the UE 120 configuring two values for the timer. For example, the network node 110 may transmit (for example, via RRC signaling, via the configuration information described in connection with reference number 705 of FIG. 7) signaling indicating a first value for the timer and a second value for the timer.

In the second timer option, the DCI 1015a may schedule an initial transmission of the transport block 1030a, and may indicate that the transport block 1030a is associated with the HARQ identifier 1020 and an NDI 1025a. The UE 120 may successfully decode the initial transmission of the transport block 1030a, and may transmit a HARQ ACK 1035a to the network node 110 and start (for example, initiate) the timer having the first value at time 1010a, relative to the HARQ ACK 1035a. At time 1010b, the network node 110 may schedule an initial transmission of the transport block 1030b (for example, via the DCI 1015b which indicates the same HARQ identifier 1020 as the initial transmission of the transport block 1030a and a second NDI 1025b). Additionally, if the UE 120 receives a DCI 1015b that indicates a same HARQ identifier 1020 (for example, with the same or different NDI 1025), the UE 120 may stop and reset the timer having the first value. Therefore, at time 1010b, the UE 120 may stop and reset the timer having the first value relative to, or otherwise based on the occurrence of the DCI 1015b indicating the same HARQ identifier 1020 as the DCI 1015a. In some other examples, stopping and resetting the first timer at time 1010b may occur relative to the communication and/or the attempted decoding of the transport block 1030b. In some other examples, stopping and resetting the first timer at time 1010d may occur relative to the communication and/or the attempted decoding of the transport block 1030c. In the second timer option of the example 1000, the UE 120 receives the DCI 1015b scheduling the retransmission of the transport block 1030b prior to the expiration of the timer having the first value.

However, the UE 120 may be unable to successfully decode the initial transmission of the transport block 1030b, and may transmit a HARQ NACK 1035b to the network node 110 and start (for example, initiate) the timer having the second value at time 1010c, relative to the HARQ NACK 1035b. The network node 110 may schedule a retransmission of the second transport block 1030c (for example, via the DCI 1015c which indicates the same HARQ identifier 1020 and NDI 1025b as the initial transmission of the second transport block 1030b). Additionally, if the UE 120 receives a DCI 1015c that indicates a same HARQ identifier 1020 (for example, with the same or different NDI 1025), the UE 120 may stop and reset the timer having the second value at time 1010d. Therefore, at time 1010d, the UE 120 may stop and reset the timer having the second value based on the DCI 1015c indicating the same HARQ identifier 1020 as the DCI 1015b. In the second option of the example 1000, the UE 120 receives the DCI 1015c scheduling the retransmission of the second transport block 1030c prior to the expiration of the timer having the second value.

Accordingly, the UE 120 does not detect an unsuccessful termination of the HARQ process associated with the transport block 1030 between times 1010a and 1010b and/or between times 1010c and 1010d.

In the second timer option of the example 1000, the UE 120 is able to successfully decode the second transport block using a combination of the initial transmission of the second transport block 1030b and the retransmission of the second transport block 1030c. Accordingly, the UE 120 transmits another HARQ ACK 1035c associated with the second transport block and starts (for example, initiates) the timer having the first value at time 1010e, relative to the HARQ ACK 1035c.

At time 1010d, the timer having the first value (e.g., having the first value and/or a first duration) may expire. In response to the timer having the first value expiring prior to the UE 120 detecting any downlink control information 1015 scheduling another retransmission associated with a transport block 1030, the UE 120 may identify an unsuccessful HARQ process termination associated with the transport block 1030 and the HARQ identifier 1020. Accordingly, the UE 120 may transmit an event indication 1045 (e.g., an unsuccessful HARQ process termination indication) to the network node 110.

In some cases, the network node 110 configuring the UE 120 to identify unsuccessful HARQ process terminations in response to an expiration of the timer having the first and/or second value may decrease a latency associated with the UE 120 detecting and reporting unsuccessful HARQ process terminations. For example, the network node 110 may not transmit an additional DCI 1015 scheduling another transport block associated with the same HARQ identifier 1020 and the NDI 1025b, which may be different from the NDI 1025a, for a long time. In the second timer option of example 1000, if the UE 120 was unable to detect or report the unsuccessful termination of the HARQ process associated with the transport block 1030 until the UE 120 received the DCI 1015, additional latency may be introduced due to the network node 110 initiating an ARQ process to retransmit one or more RLC SDUs or RLC SDU segments associated with the transport block 1030. In another example, the UE 120 may fail to receive or decode the additional DCI 1015 scheduling the other transport block with the same HARQ identifier 1020 as the transport block 1030. In such examples, the UE 120 may fail to identify the unsuccessful termination of the HARQ process associated with the transport block 1030 without the timer.

According to the example 1000, the duration that a HARQ ID remains unused (e.g., resulting in reporting the corresponding event) may be different for examples where a transport block 1030 is decoded than the duration for examples where a transport block 1030 is unsuccessfully decoded.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with feedback identifier reporting.

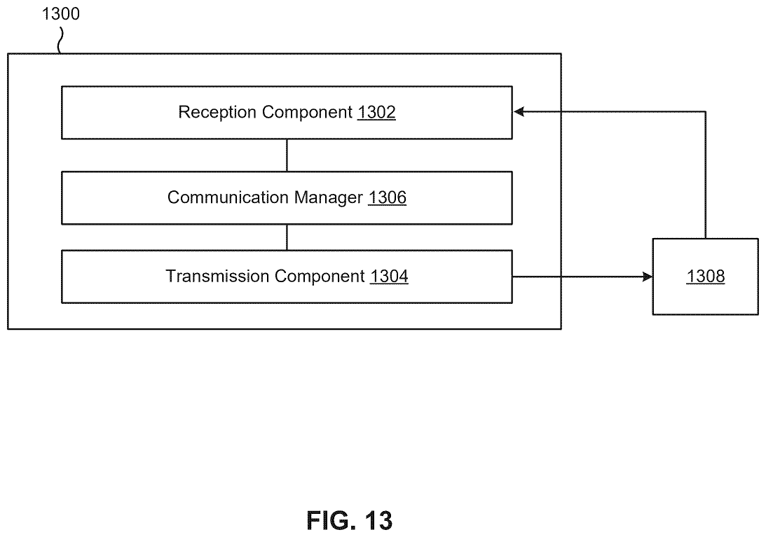

As shown in FIG. 11, in some aspects, process 1100 may include receiving a downlink communication associated with a HARQ process identifier (block 1110). For example, the UE (e.g., using reception component 1302 and/or communication manager 1306, depicted in FIG. 13) may receive a downlink communication associated with a HARQ process identifier, as described above in connection with reference number 715 of FIG. 7.

As further shown in FIG. 11, in some aspects, process 1100 may include initiating a timer associated with the HARQ process identifier in accordance with the downlink communication or in accordance with a feedback communication associated with the downlink communication (block 1120). For example, the UE (e.g., using communication manager 1306, depicted in FIG. 13) may initiate a timer associated with the HARQ process identifier in accordance with the downlink communication or in accordance with a feedback communication associated with the downlink communication, as described above in connection with reference number 730 of FIG. 7.

As further shown in FIG. 11, in some aspects, process 1100 may include transmitting an indication of an event associated with the HARQ process identifier in association with an expiration of the timer (block 1130). For example, the UE (e.g., using transmission component 1304 and/or communication manager 1306, depicted in FIG. 13) may transmit an indication of an event associated with the HARQ process identifier in association with an expiration of the timer, as described above in connection with reference number 750 of FIG. 7.

Process 1100 may include additional aspects, such as any single aspect or any combination of aspects described below and/or in connection with one or more other processes described elsewhere herein.

In a first aspect, process 1100 includes receiving configuration information indicating a value of the timer associated with the HARQ process identifier.

In a second aspect, alone or in combination with the first aspect, process 1100 includes receiving radio resource control signaling including the configuration information indicating the value of the timer.

In a third aspect, alone or in combination with one or more of the first and second aspects, the configuration information indicates that the value of the timer is to be associated with at least one of the HARQ process identifier, a component carrier of the downlink communication, or a component carrier group for the downlink communication.

In a fourth aspect, alone or in combination with one or more of the first through third aspects, the downlink communication includes at least one of a physical downlink shared channel message, or a downlink control information message.

In a fifth aspect, alone or in combination with one or more of the first through fourth aspects, process 1100 includes initiating the timer in response to receiving at least one of control information associated with the downlink communication, or the downlink communication.

In a sixth aspect, alone or in combination with one or more of the first through fifth aspects, process 1100 includes transmitting the feedback communication associated with the downlink communication, wherein initiating the timer associated with the HARQ process identifier comprises initiating the timer after transmitting the feedback communication.

In a seventh aspect, alone or in combination with one or more of the first through sixth aspects, process 1100 includes terminating the timer in response to receiving control information associated with the downlink communication, wherein initiating the timer after transmitting the feedback communication comprises reinitiating the timer after transmitting the feedback communication associated with receiving the downlink communication.

In an eighth aspect, alone or in combination with one or more of the first through seventh aspects, the indication of the event indicates that the HARQ process identifier was unassociated with a second downlink communication occurring after the timer was initiated and before the expiration of the timer.

In a ninth aspect, alone or in combination with one or more of the first through eighth aspects, process 1100 includes receiving a second downlink communication associated with the HARQ process identifier, and reinitiating the timer associated with the HARQ process identifier in accordance with at least one of receiving the second downlink communication or transmitting a second feedback communication associated with the second downlink communication, wherein transmitting the indication of the event comprises transmitting, after reinitiating the timer, the indication of the event associated with the HARQ process identifier in association with the expiration of the timer.

In a tenth aspect, alone or in combination with one or more of the first through ninth aspects, the feedback communication includes at least one of an acknowledgement indication or a negative acknowledgement indication.

In an eleventh aspect, alone or in combination with one or more of the first through tenth aspects, process 1100 includes receiving configuration information indicating a first value of the timer associated with acknowledgement indications and a second value of the timer associated with negative acknowledgement indications.

In a twelfth aspect, alone or in combination with one or more of the first through eleventh aspects, the timer includes a first timer and a second timer, wherein the first timer is associated with acknowledgement indications and the second timer is associated with negative acknowledgement indications, and process 1100 includes receiving configuration information indicating a first value for the first timer and a second value for the second timer.

In a thirteenth aspect, alone or in combination with one or more of the first through twelfth aspects, process 1100 includes transmitting the feedback communication, wherein the feedback communication includes an acknowledgement indication associated with the downlink communication, and initiating the timer associated with the HARQ process identifier comprises initiating the first timer having the first value after transmitting the feedback communication.

In a fourteenth aspect, alone or in combination with one or more of the first through thirteenth aspects, process 1100 includes transmitting the feedback communication, wherein the feedback communication includes a negative acknowledgement indication associated with the downlink communication, and initiating the timer associated with the HARQ process identifier comprises initiating the second timer having the second value in response to transmitting the feedback communication.

In a fifteenth aspect, alone or in combination with one or more of the first through fourteenth aspects, process 1100 includes terminating a first instance of at least one of the first timer or the second timer in response to receiving at least one of control information associated with the downlink communication, or the downlink communication, transmitting the feedback communication, wherein the feedback communication includes at least one of a negative acknowledgement indication or an acknowledgement indication, associated with the downlink communication, and initiating the timer associated with the HARQ process identifier comprises initiating a second instance of at least one of the first timer or the second timer in response to transmitting the feedback communication.

In a sixteenth aspect, alone or in combination with one or more of the first through fifteenth aspects, the second timer is associated with the HARQ process identifier.

In a seventeenth aspect, alone or in combination with one or more of the first through sixteenth aspects, the configuration information indicates that the first value and the second value are to be associated with at least one of the HARQ process identifier, a component carrier of the downlink communication, or a component carrier group for the downlink communication.

In an eighteenth aspect, alone or in combination with one or more of the first through seventeenth aspects, process 1100 includes transmitting the indication of the event associated with the HARQ process identifier comprises transmitting the indication of the event associated with the HARQ process identifier in association with an expiration of the second timer.

In a nineteenth aspect, alone or in combination with one or more of the first through eighteenth aspects, the indication of the event includes one or more of the HARQ process identifier, a new data indicator associated with the downlink communication, an indication of at least one of a component carrier or a component carrier group associated with receiving the downlink communication, an indication of whether the feedback communication, in accordance with initiating the timer, included at least one of an acknowledgement indication or a negative acknowledgement indication, a time stamp indicating when the expiration of the timer occurred, or a time stamp indicating when initiation of the timer occurred.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with feedback identifier reporting.

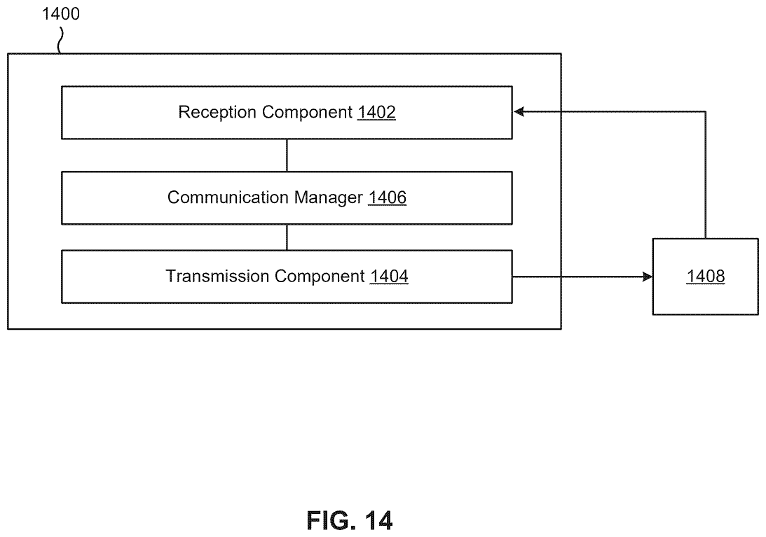

As shown in FIG. 12, in some aspects, process 1200 may include transmitting a downlink communication associated with a HARQ process identifier (block 1210). For example, the network node (e.g., using transmission component 1404 and/or communication manager 1406, depicted in FIG. 14) may transmit a downlink communication associated with a HARQ process identifier, as described above in connection with reference number 715 of FIG. 7.

As further shown in FIG. 12, in some aspects, process 1200 may include receiving an indication of an event associated with the HARQ process identifier in association with an expiration of a timer associated with the downlink communication or associated with a feedback communication associated with the downlink communication (block 1220). For example, the network node (e.g., using reception component 1402 and/or communication manager 1406, depicted in FIG. 14) may receive an indication of an event associated with the HARQ process identifier in association with an expiration of a timer associated with the downlink communication or associated with a feedback communication associated with the downlink communication, as described above in connection with reference number 750 of FIG. 7.

Process 1200 may include additional aspects, such as any single aspect or any combination of aspects described below and/or in connection with one or more other processes described elsewhere herein.

In a first aspect, process 1200 includes transmitting configuration information indicating a value of the timer, wherein the timer is associated with the HARQ process identifier.

In a second aspect, alone or in combination with the first aspect, process 1200 includes transmitting radio resource control signaling including the configuration information indicating the value of the timer.

In a third aspect, alone or in combination with one or more of the first and second aspects, the configuration information indicates that the value of the timer is to be associated with at least one of the HARQ process identifier, a component carrier of the downlink communication, or a component carrier group for the downlink communication.

In a fourth aspect, alone or in combination with one or more of the first through third aspects, the downlink communication includes at least one of a physical downlink shared channel message, or a downlink control information message.

In a fifth aspect, alone or in combination with one or more of the first through fourth aspects, the indication of the event indicates that the HARQ process identifier was unassociated with a second downlink communication occurring after an initiation of the timer and before the expiration of the timer.

In a sixth aspect, alone or in combination with one or more of the first through fifth aspects, process 1200 includes transmitting a second downlink communication associated with the HARQ process identifier, and receiving the indication of the event comprises receiving the indication of the event associated with the HARQ process identifier in association with the expiration of the timer being associated with the second downlink communication or being associated with a second feedback communication associated with the second downlink communication.

In a seventh aspect, alone or in combination with one or more of the first through sixth aspects, the feedback communication includes at least one of an acknowledgement indication or a negative acknowledgement indication.

In an eighth aspect, alone or in combination with one or more of the first through seventh aspects, process 1200 includes transmitting configuration information indicating a first value of the timer associated with positive acknowledgement indications and a second value of the timer associated with negative acknowledgement indications.

In a ninth aspect, alone or in combination with one or more of the first through eighth aspects, the timer includes a first timer and a second timer, the first timer is associated with acknowledgement indications and the second timer is associated with negative acknowledgement indications, and the process 1200 includes transmitting configuration information indicating a first value for the first timer and a second value for the second timer.

In a tenth aspect, alone or in combination with one or more of the first through ninth aspects, process 1200 includes receiving the feedback communication, wherein the feedback communication includes an acknowledgement indication associated with the downlink communication, and the expiration of the timer is relative to a communication time of the feedback communication.

In an eleventh aspect, alone or in combination with one or more of the first through tenth aspects, process 1200 includes receiving the feedback communication, wherein the feedback communication includes a negative acknowledgement indication associated with the downlink communication, and the expiration of the timer is relative to a communication time of the feedback communication.

In a twelfth aspect, alone or in combination with one or more of the first through eleventh aspects, the second timer is associated with the HARQ process identifier.

In a thirteenth aspect, alone or in combination with one or more of the first through twelfth aspects, the configuration information indicates that the first value and the second value are to be associated with at least one of the HARQ process identifier, a component carrier of the downlink communication, or a component carrier group for the downlink communication.

In a fourteenth aspect, alone or in combination with one or more of the first through thirteenth aspects, process 1200 includes receiving the indication of the event associated with the HARQ process identifier in association with an expiration of the second timer.

In a fifteenth aspect, alone or in combination with one or more of the first through fourteenth aspects, the indication of the event includes one or more of the HARQ process identifier, a new data indicator associated with the downlink communication, an indication of at least one of a component carrier or a component carrier group, associated with receiving the downlink communication, an indication of whether the feedback communication, in accordance with initiating the timer, included at least one of an acknowledgement indication or a negative acknowledgement indication, a time stamp indicating when the expiration of the timer occurred, or a time stamp indicating when initiation of the timer occurred.

In a sixteenth aspect, alone or in combination with one or more of the first through fifteenth aspects, process 1200 includes receiving the feedback communication including an acknowledgement indication, wherein the indication of the event includes an indication that the expiration of the timer is relative to the feedback communication.

In a seventeenth aspect, alone or in combination with one or more of the first through sixteenth aspects, process 1200 includes transmitting, before the expiration of the timer, a second downlink communication associated with the HARQ process ID, and performing an automatic repeat request procedure for the second downlink communication in accordance with the indication that the expiration of the timer is relative to the feedback communication.

In an eighteenth aspect, alone or in combination with one or more of the first through seventeenth aspects, process 1200 includes refraining from performing an automatic repeat request procedure in accordance with the indication that the expiration of the timer is relative to the feedback communication.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 7-10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a downlink communication associated with a HARQ process identifier. The communication manager 1306 may initiate a timer associated with the HARQ process identifier in accordance with the downlink communication or in accordance with a feedback communication associated with the downlink communication. The transmission component 1304 may transmit an indication of an event associated with the HARQ process identifier in association with an expiration of the timer.

The reception component 1302 may receive configuration information indicating a value of the timer associated with the HARQ process identifier.

The transmission component 1304 may transmit the feedback communication associated with the downlink communication wherein initiating the timer associated with the HARQ process identifier comprises initiating the timer after transmitting the feedback communication.

The communication manager 1306 may terminate the timer in response to receiving control information associated with the downlink communication wherein initiating the timer after transmitting the feedback communication comprises reinitiating the timer after transmitting the feedback communication associated with receiving the downlink communication.

The reception component 1302 may receive a second downlink communication associated with the HARQ process identifier.

The communication manager 1306 may reinitiate the timer associated with the HARQ process identifier in accordance with at least one of receiving the second downlink communication or transmitting a second feedback communication associated with the second downlink communication wherein transmitting the indication of the event comprises transmitting, after reinitiating the timer, the indication of the event associated with the HARQ process identifier in association with the expiration of the timer.

The reception component 1302 may receive configuration information indicating a first value of the timer associated with acknowledgement indications and a second value of the timer associated with negative acknowledgement indications.

The transmission component 1304 may transmit the feedback communication, wherein the feedback communication includes an acknowledgement indication associated with the downlink communication.

The transmission component 1304 may transmit the feedback communication, wherein the feedback communication includes a negative acknowledgement indication associated with the downlink communication.

The communication manager 1306 may terminate a first instance of at least one of the first timer or the second timer in response to receiving at least one of control information associated with the downlink communication, or the downlink communication.

The transmission component 1304 may transmit the feedback communication, wherein the feedback communication includes at least one of a negative acknowledgement indication or an acknowledgement indication, associated with the downlink communication wherein initiating the timer associated with the HARQ process identifier comprises initiating a second instance of at least one of the first timer or the second timer in response to transmitting the feedback communication.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 7-10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the network node described in connection with FIG. 1 and FIG. 2. Additionally, or alternatively, one or more components shown in FIG. 14 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit a downlink communication associated with a HARQ process identifier. The reception component 1402 may receive an indication of an event associated with the HARQ process identifier in association with an expiration of a timer associated with the downlink communication or associated with a feedback communication associated with the downlink communication.

The transmission component 1404 may transmit configuration information indicating a value of the timer, wherein the timer is associated with the HARQ process identifier.

The transmission component 1404 may transmit a second downlink communication associated with the HARQ process identifier wherein receiving the indication of the event comprises receiving the indication of the event associated with the HARQ process identifier in association with the expiration of the timer being associated with the second downlink communication or being associated with a second feedback communication associated with the second downlink communication.

The transmission component 1404 may transmit configuration information indicating a first value of the timer associated with positive acknowledgement indications and a second value of the timer associated with negative acknowledgement indications.

The reception component 1402 may receive the feedback communication, wherein the feedback communication includes an acknowledgement indication associated with the downlink communication, and wherein the expiration of the timer is relative to a communication time of the feedback communication.

The reception component 1402 may receive the feedback communication, wherein the feedback communication includes a negative acknowledgement indication associated with the downlink communication, and wherein the expiration of the timer is relative to a communication time of the feedback communication.

The reception component 1402 may receive the feedback communication including an acknowledgement indication, wherein the indication of the event includes an indication that the expiration of the timer is relative to the feedback communication.

The transmission component 1404 may transmit, before the expiration of the timer, a second downlink communication associated with the HARQ process ID.

The communication manager 1406 may perform an automatic repeat request procedure for the second downlink communication in accordance with the indication that the expiration of the timer is relative to the feedback communication.

The communication manager 1406 may refrain from performing an automatic repeat request procedure in accordance with the indication that the expiration of the timer is relative to the feedback communication.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: receiving a downlink communication associated with a HARQ process identifier; initiating a timer associated with the HARQ process identifier in accordance with the downlink communication or in accordance with a feedback communication associated with the downlink communication; and transmitting an indication of an event associated with the HARQ process identifier in association with an expiration of the timer.

Aspect 2: The method of Aspect 1, further comprising: receiving configuration information indicating a value of the timer associated with the HARQ process identifier.

Aspect 3: The method of Aspect 2, wherein receiving the configuration information comprises: receiving radio resource control signaling including the configuration information indicating the value of the timer.

Aspect 4: The method of any of Aspects 2-3, wherein the configuration information indicates that the value of the timer is to be associated with at least one of the HARQ process identifier, a component carrier of the downlink communication, or a component carrier group for the downlink communication.

Aspect 5: The method of any of Aspects 1-4, wherein the downlink communication includes at least one of a physical downlink shared channel message, or a downlink control information message.

Aspect 6: The method of any of Aspects 1-5, wherein initiating the timer associated with the HARQ process identifier comprises: initiating the timer in response to receiving at least one of control information associated with the downlink communication, or the downlink communication.

Aspect 7: The method of any of Aspects 1-6, further comprising: transmitting the feedback communication associated with the downlink communication, wherein initiating the timer associated with the HARQ process identifier comprises initiating the timer after transmitting the feedback communication.

Aspect 8: The method of Aspect 7, further comprising: terminating the timer in response to receiving control information associated with the downlink communication, wherein initiating the timer after transmitting the feedback communication comprises reinitiating the timer after transmitting the feedback communication associated with receiving the downlink communication.

Aspect 9: The method of any of Aspects 1-8, wherein the indication of the event indicates that the HARQ process identifier was unassociated with a second downlink communication occurring after the timer was initiated and before the expiration of the timer.

Aspect 10: The method of any of Aspects 1-9, further comprising: receiving a second downlink communication associated with the HARQ process identifier; and reinitiating the timer associated with the HARQ process identifier in accordance with at least one of receiving the second downlink communication or transmitting a second feedback communication associated with the second downlink communication, wherein transmitting the indication of the event comprises transmitting, after reinitiating the timer, the indication of the event associated with the HARQ process identifier in association with the expiration of the timer.

Aspect 11: The method of any of Aspects 1-10, wherein the feedback communication includes at least one of an acknowledgement indication or a negative acknowledgement indication.

Aspect 12: The method of any of Aspects 1-11, further comprising: receiving configuration information indicating a first value of the timer associated with acknowledgement indications and a second value of the timer associated with negative acknowledgement indications.

Aspect 13: The method of any of Aspects 1-11, wherein the timer includes a first timer and a second timer, wherein the first timer is associated with acknowledgement indications and the second timer is associated with negative acknowledgement indications, and the method further comprises: receiving configuration information indicating a first value for the first timer and a second value for the second timer.

Aspect 14: The method of Aspect 13, further comprising: transmitting the feedback communication, wherein the feedback communication includes an acknowledgement indication associated with the downlink communication, and wherein initiating the timer associated with the HARQ process identifier comprises initiating the first timer having the first value after transmitting the feedback communication, wherein initiating the timer associated with the HARQ process identifier comprises initiating the first timer having the first value after transmitting the feedback communication.

Aspect 15: The method of Aspect 13, further comprising: transmitting the feedback communication, wherein the feedback communication includes a negative acknowledgement indication associated with the downlink communication, and wherein initiating the timer associated with the HARQ process identifier comprises initiating the second timer having the second value in response to transmitting the feedback communication, wherein initiating the timer associated with the HARQ process identifier comprises initiating the second timer having the second value in response to transmitting the feedback communication.

Aspect 16: The method of any of Aspects 13-15, further comprising: terminating a first instance of at least one of the first timer or the second timer in response to receiving at least one of control information associated with the downlink communication, or the downlink communication, transmitting the feedback communication, wherein the feedback communication includes at least one of a negative acknowledgement indication or an acknowledgement indication, associated with the downlink communication, and wherein initiating the timer associated with the HARQ process identifier comprises initiating a second instance of at least one of the first timer or the second timer in response to transmitting the feedback communication.

Aspect 17: The method of any of Aspects 13-16, wherein the second timer is associated with the HARQ process identifier.

Aspect 18: The method of any of Aspects 13-17, wherein the configuration information indicates that the first value and the second value are to be associated with at least one of the HARQ process identifier, a component carrier of the downlink communication, or a component carrier group for the downlink communication.

Aspect 19: The method of any of Aspects 13, and 15-18, wherein transmitting the indication of the event associated with the HARQ process identifier comprises transmitting the indication of the event associated with the HARQ process identifier in association with an expiration of the second timer.

Aspect 20: The method of any of Aspects 1-19, wherein the indication of the event includes one or more of: the HARQ process identifier, a new data indicator associated with the downlink communication, an indication of at least one of a component carrier or a component carrier group associated with receiving the downlink communication, an indication of whether the feedback communication, in accordance with initiating the timer, included at least one of an acknowledgement indication or a negative acknowledgement indication, a time stamp indicating when the expiration of the timer occurred, or a time stamp indicating when initiation of the timer occurred.

Aspect 21: A method of wireless communication performed by a network node, comprising: transmitting a downlink communication associated with a HARQ process identifier; and receiving an indication of an event associated with the HARQ process identifier in association with an expiration of a timer associated with the downlink communication or associated with a feedback communication associated with the downlink communication.

Aspect 22: The method of Aspect 21, further comprising: transmitting configuration information indicating a value of the timer, wherein the timer is associated with the HARQ process identifier.

Aspect 23: The method of Aspect 22, wherein transmitting the configuration information comprises transmitting radio resource control signaling including the configuration information indicating the value of the timer.

Aspect 24: The method of any of Aspects 22-23, wherein the configuration information indicates that the value of the timer is to be associated with at least one of the HARQ process identifier, a component carrier of the downlink communication, or a component carrier group for the downlink communication.

Aspect 25: The method of any of Aspects 21-24, wherein the downlink communication includes at least one of a physical downlink shared channel message, or a downlink control information message.

Aspect 26: The method of any of Aspects 21-25, wherein the indication of the event indicates that the HARQ process identifier was unassociated with a second downlink communication occurring after an initiation of the timer and before the expiration of the timer.

Aspect 27: The method of any of Aspects 21-26, further comprising: transmitting a second downlink communication associated with the HARQ process identifier, wherein receiving the indication of the event comprises receiving the indication of the event associated with the HARQ process identifier in association with the expiration of the timer being associated with the second downlink communication or being associated with a second feedback communication associated with the second downlink communication.

Aspect 28: The method of any of Aspects 21-27, wherein the feedback communication includes at least one of an acknowledgement indication or a negative acknowledgement indication.

Aspect 29: The method of any of Aspects 21-28, further comprising: transmitting configuration information indicating a first value of the timer associated with positive acknowledgement indications and a second value of the timer associated with negative acknowledgement indications.

Aspect 30: The method of any of Aspects 21-29, wherein the timer includes a first timer and a second timer, wherein the first timer is associated with acknowledgement indications and the second timer is associated with negative acknowledgement indications, and the method further comprises: transmitting configuration information indicating a first value for the first timer and a second value for the second timer.

Aspect 31: The method of Aspect 30, further comprising: receiving the feedback communication, wherein the feedback communication includes an acknowledgement indication associated with the downlink communication, and wherein the expiration of the timer is relative to a communication time of the feedback communication.

Aspect 32: The method of Aspect 30, further comprising: receiving the feedback communication, wherein the feedback communication includes a negative acknowledgement indication associated with the downlink communication, and wherein the expiration of the timer is relative to a communication time of the feedback communication.

Aspect 33: The method of any of Aspects 30-32, wherein the second timer is associated with the HARQ process identifier.

Aspect 34: The method of any of Aspects 30-33, wherein the configuration information indicates that the first value and the second value are to be associated with at least one of the HARQ process identifier, a component carrier of the downlink communication, or a component carrier group for the downlink communication.

Aspect 35: The method of any of Aspects 30, and 32-34, wherein receiving the indication of the event associated with the HARQ process identifier comprises receiving the indication of the event associated with the HARQ process identifier in association with an expiration of the second timer.

Aspect 36: The method of any of Aspects 21-35, wherein the indication of the event includes one or more of: the HARQ process identifier, a new data indicator associated with the downlink communication, an indication of at least one of a component carrier or a component carrier group, associated with receiving the downlink communication, an indication of whether the feedback communication, in accordance with initiating the timer, included at least one of an acknowledgement indication or a negative acknowledgement indication, a time stamp indicating when the expiration of the timer occurred, or a time stamp indicating when initiation of the timer occurred.

Aspect 37: The method of any of Aspects 21-36, further comprising: receiving the feedback communication including an acknowledgement indication, wherein the indication of the event includes an indication that the expiration of the timer is relative to the feedback communication.

Aspect 38: The method of Aspect 37, further comprising: transmitting, before the expiration of the timer, a second downlink communication associated with the HARQ process ID; and performing an automatic repeat request procedure for the second downlink communication in accordance with the indication that the expiration of the timer is relative to the feedback communication.

Aspect 39: The method of Aspect 37, further comprising: refraining from performing an automatic repeat request procedure in accordance with the indication that the expiration of the timer is relative to the feedback communication.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-39.

Aspect 41: An apparatus for wireless communication at a device, the apparatus comprising one or more memories and one or more processors coupled to the one or more memories, the one or more processors configured to cause the device to perform the method of one or more of Aspects 1-39.

Aspect 42: An apparatus for wireless communication, the apparatus comprising at least one means for performing the method of one or more of Aspects 1-39.

Aspect 43: A non-transitory computer-readable medium storing code for wireless communication, the code comprising instructions executable by one or more processors to perform the method of one or more of Aspects 1-39.

Aspect 44: A non-transitory computer-readable medium storing a set of instructions for wireless communication, the set of instructions comprising one or more instructions that, when executed by one or more processors of a device, cause the device to perform the method of one or more of Aspects 1-39.

Aspect 45: A device for wireless communication, the device comprising a processing system that includes one or more processors and one or more memories coupled with the one or more processors, the processing system configured to cause the device to perform the method of one or more of Aspects 1-39.

Aspect 46: An apparatus for wireless communication at a device, the apparatus comprising one or more memories and one or more processors coupled to the one or more memories, the one or more processors individually or collectively configured to cause the device to perform the method of one or more of Aspects 1-39.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a downlink communication associated with a hybrid automatic repeat request (HARQ) process identifier;
initiate a timer associated with the HARQ process identifier in accordance with the downlink communication or in accordance with a feedback communication associated with the downlink communication; and
transmit an indication of an event associated with the HARQ process identifier in association with an expiration of the timer.

2. The apparatus of claim 1, wherein the one or more processors are further configured to cause the UE to:
receive configuration information indicating a value of the timer associated with the HARQ process identifier.

3. The apparatus of claim 2, wherein the one or more processors, to cause the UE to receive the configuration information, are configured to cause the UE to:
receive radio resource control signaling including the configuration information indicating the value of the timer.

4. The apparatus of claim 2, wherein the configuration information indicates that the value of the timer is to be associated with at least one of the HARQ process identifier, a component carrier of the downlink communication, or a component carrier group for the downlink communication.

5. The apparatus of claim 1, wherein the one or more processors, to cause the UE to initiate the timer associated with the HARQ process identifier, are configured to cause the UE to:
initiate the timer in response to receiving at least one of control information associated with the downlink communication, or the downlink communication.

6. The apparatus of claim 1, wherein the one or more processors are further configured to cause the UE to:
transmit the feedback communication associated with the downlink communication,
wherein the one or more processors, to cause the UE to initiate the timer associated with the HARQ process identifier, are configured to cause the UE to initiate the timer after transmitting the feedback communication.

7. The apparatus of claim 6, wherein the one or more processors are further configured to cause the UE to:
terminate the timer in response to receiving control information associated with the downlink communication,
wherein the one or more processors, to cause the UE to initiate the timer after transmitting the feedback communication, are configured to cause the UE to reinitiate the timer after transmitting the feedback communication associated with receiving the downlink communication.

8. The apparatus of claim 1, wherein the one or more processors are further configured to cause the UE to:
receive a second downlink communication associated with the HARQ process identifier; and
reinitiate the timer associated with the HARQ process identifier in accordance with at least one of receiving the second downlink communication or transmitting a second feedback communication associated with the second downlink communication,
wherein the one or more processors, to cause the UE to transmit the indication of the event, are configured to cause the UE to transmit, after reinitiating the timer, the indication of the event associated with the HARQ process identifier in association with the expiration of the timer.

9. The apparatus of claim 1, wherein the one or more processors are further configured to cause the UE to:
receive configuration information indicating a first value of the timer associated with acknowledgement indications and a second value of the timer associated with negative acknowledgement indications.

10. The apparatus of claim 1, wherein the indication of the event includes one or more of:
the HARQ process identifier,
a new data indicator associated with the downlink communication,
an indication of at least one of a component carrier or a component carrier group associated with receiving the downlink communication,
an indication of whether the feedback communication, in accordance with initiating the timer, included at least one of an acknowledgement indication or a negative acknowledgement indication,
a time stamp indicating when the expiration of the timer occurred, or
a time stamp indicating when initiation of the timer occurred.

11. An apparatus for wireless communication at a network node, comprising:
one or more memories; and
one or more processors, coupled to the one or more memories, configured to cause the network node to:
transmit a downlink communication associated with a hybrid automatic repeat request (HARQ) process identifier; and
receive an indication of an event associated with the HARQ process identifier in association with an expiration of a timer associated with the downlink communication or associated with a feedback communication associated with the downlink communication.

12. The apparatus of claim 11, wherein the one or more processors are further configured to cause the network node to:
transmit a second downlink communication associated with the HARQ process identifier,
wherein the one or more processors, to cause the network node to receive the indication of the event, are configured to cause the network node to receive the indication of the event associated with the HARQ process identifier in association with the expiration of the timer being associated with the second downlink communication or being associated with a second feedback communication associated with the second downlink communication.

13. The apparatus of claim 11, wherein the one or more processors are further configured to cause the network node to:
transmit configuration information indicating a first value of the timer associated with positive acknowledgement indications and a second value of the timer associated with negative acknowledgement indications.

14. The apparatus of claim 11, wherein the indication of the event includes one or more of:
the HARQ process identifier,
a new data indicator associated with the downlink communication,
an indication of at least one of a component carrier or a component carrier group, associated with receiving the downlink communication,
an indication of whether the feedback communication, in accordance with initiating the timer, included at least one of an acknowledgement indication or a negative acknowledgement indication,
a time stamp indicating when the expiration of the timer occurred, or
a time stamp indicating when initiation of the timer occurred.

15. The apparatus of claim 11, wherein the one or more processors are further configured to cause the network node to:
receive the feedback communication including an acknowledgement indication, wherein the indication of the event includes an indication that the expiration of the timer is relative to the feedback communication.

16. The apparatus of claim 15, wherein the one or more processors are further configured to cause the network node to:
transmit, before the expiration of the timer, a second downlink communication associated with the HARQ process ID; and
perform an automatic repeat request procedure for the second downlink communication in accordance with the indication that the expiration of the timer is relative to the feedback communication.

17. The apparatus of claim 15, wherein the one or more processors are further configured to cause the network node to:
refrain from performing an automatic repeat request procedure in accordance with the indication that the expiration of the timer is relative to the feedback communication.

18. A method of wireless communication performed by a user equipment (UE), comprising:
receiving a downlink communication associated with a hybrid automatic repeat request (HARQ) process identifier;
initiating a timer associated with the HARQ process identifier in accordance with the downlink communication or in accordance with a feedback communication associated with the downlink communication; and
transmitting an indication of an event associated with the HARQ process identifier in association with an expiration of the timer.

19. The method of claim 18, wherein the timer includes a first timer and a second timer, wherein the first timer is associated with acknowledgement indications and the second timer is associated with negative acknowledgement indications, and the method further comprises:
receiving configuration information indicating a first value for the first timer and a second value for the second timer.

20. The method of claim 19, further comprising:
transmitting the feedback communication, wherein the feedback communication includes an acknowledgement indication associated with the downlink communication, and
wherein initiating the timer associated with the HARQ process identifier comprises initiating the first timer having the first value after transmitting the feedback communication.

21. The method of claim 19, further comprising:
transmitting the feedback communication, wherein the feedback communication includes a negative acknowledgement indication associated with the downlink communication, and
wherein initiating the timer associated with the HARQ process identifier comprises initiating the second timer having the second value in response to transmitting the feedback communication.

22. The method of claim 19, further comprising:
terminating a first instance of at least one of the first timer or the second timer in response to receiving at least one of control information associated with the downlink communication, or the downlink communication,
transmitting the feedback communication, wherein the feedback communication includes at least one of a negative acknowledgement indication or an acknowledgement indication, associated with the downlink communication, and
wherein initiating the timer associated with the HARQ process identifier comprises initiating a second instance of at least one of the first timer or the second timer in response to transmitting the feedback communication.

23. The method of claim 19, wherein the configuration information indicates that the first value and the second value are to be associated with at least one of the HARQ process identifier, a component carrier of the downlink communication, or a component carrier group for the downlink communication.

24. The method of claim 19, wherein transmitting the indication of the event associated with the HARQ process identifier comprises transmitting the indication of the event associated with the HARQ process identifier in association with an expiration of the second timer.

25. A method of wireless communication performed by a network node, comprising:
transmitting a downlink communication associated with a hybrid automatic repeat request (HARQ) process identifier; and
receiving an indication of an event associated with the HARQ process identifier in association with an expiration of a timer associated with the downlink communication or associated with a feedback communication associated with the downlink communication.

26. The method of claim 25, wherein the timer includes a first timer and a second timer, wherein the first timer is associated with acknowledgement indications and the second timer is associated with negative acknowledgement indications, and the method further comprises:
transmitting configuration information indicating a first value for the first timer and a second value for the second timer.

27. The method of claim 26, further comprising:
receiving the feedback communication, wherein the feedback communication includes an acknowledgement indication associated with the downlink communication, and wherein the expiration of the timer is relative to a communication time of the feedback communication.

28. The method of claim 26, further comprising:
receiving the feedback communication, wherein the feedback communication includes a negative acknowledgement indication associated with the downlink communication, and wherein the expiration of the timer is relative to a communication time of the feedback communication.

29. The method of claim 26, wherein the configuration information indicates that the first value and the second value are to be associated with at least one of the HARQ process identifier, a component carrier of the downlink communication, or a component carrier group for the downlink communication.

30. The method of claim 26, wherein receiving the indication of the event associated with the HARQ process identifier comprises receiving the indication of the event associated with the HARQ process identifier in association with an expiration of the second timer.
